(19) United States
(12) Patent Application Publication
(10) Pub. No.: US 2025/0192226 A1
(43) Pub. Date: Jun. 12, 2025

(54) SOLID-STATE ELECTROLYTE PROCESSING AND METHODS OF USE THEREOF

(71) Applicant: ARIZONA BOARD OF REGENTS ON BEHALF OF ARIZONA STATE UNIVERSITY, Scottsdale, AZ (US)

(72) Inventors: Nicholas Rolston, Phoenix, AZ (US); Candace Chan, Phoenix, AZ (US); Mohammed Sahal, Tempe, AZ (US); Jinzhao Guo, Mesa, AZ (US)

(21) Appl. No.: 18/972,716

(22) Filed: Dec. 6, 2024

Related U.S. Application Data
(60) Provisional application No. 63/607,474, filed on Dec. 7, 2023.

(51) Int. Cl. H01M 10/0562; H01M 10/0525

(52) U.S. Cl. CPC H01M 10/0562; H01M 10/0525; H01M 2300/0077

(57) ABSTRACT

The present disclosure encompasses methods of processing solid state electrolytes and compositions thereof.

This application claims priority to U.S. Provisional Application No. 63/607,474 filed on Dec. 7, 2023, the entire contents of which are incorporated herein by reference.

### GOVERNMENT INTERESTS

This invention was invention was made with government support under 2234636 awarded by the National Science Foundation. The government has certain rights in the invention.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF THE INVENTION

The present invention relates to solid state electrolyte treatment and methods of use thereof.

### BACKGROUND OF THE INVENTION

Current forms of lithium carbonate removal involve mechanical polishing/grinding or high-temperature treatments for long periods of time (multiple hours) and the need to process in an inert or vacuum environment. This can also be used on both pellets and thin films, whereby polishing/grinding has the possibility to create defects and damage to thin films.

### SUMMARY OF THE INVENTION

Aspects of the invention are drawn towards a method of removing Li₂CO₃ from a lithium-ion solid-state electrolyte material to improve material performance, the method comprising: exposing a lithium-ion solid-state electrolyte material to an atmospheric plasma discharge for an exposure period, thereby removing Li₂CO₃; and terminating the atmospheric plasma discharge exposure, thereby producing a solid-state electrolyte with improved material performance. In embodiments, the atmospheric plasma discharge source is modified with a shroud surrounding the plasma discharge source, and wherein the shroud comprises a shroud gas injection source. In embodiments, the shroud generates higher fluxes and increases surface reactions. In embodiments, the method further comprises flowing a shroud gas over the material after terminating the plasma discharge exposure, thereby cooling the material and decreasing side reactions. In embodiments, the atmospheric plasma discharge is thermal or nonthermal. In embodiments, the nonthermal atmospheric plasma discharge comprises corona discharges, atmospheric pressure glow discharges, dielectric barrier discharges, and blown arc discharges; and wherein the thermal atmospheric plasma discharge comprises high-intensity arc discharges and plasma torches. In embodiments, the exposure period comprises about 5 seconds to about 1 hour. In embodiments, the atmospheric plasma discharge is open to ambient air or is contained within an enclosure providing a controlled atmosphere. In embodiments, the plasma discharge is a non-thermal blown-arc discharge. In embodiments, the plasma discharge temperature comprises a temperature of less than about 100° C. to about 3000° C. In embodiments, the atmospheric plasma discharge has an ionization gas flow rate of about 15 lpm to about 50 lpm. In embodiments, the atmospheric plasma discharge source is at a distance of about 0.5 mm to about 10 mm from the material during the exposure period. In embodiments, the shroud gas is selected from N₂, O₂, Ar, or a combination thereof. In embodiments, the shroud gas is flowed over the material at a rate of about 5 lpm to about 100 lpm. In embodiments, the lithium-ion solid-state electrolyte is a lithium lanthanum zirconium oxide (Li₇La₃Zr₂O₁₂). In embodiments, the lithium lanthanum zirconium oxide further comprises one or more dopants selected from the group consisting of Al, Ga, Nb, or Ta. In embodiments, the lithium lanthanum zirconium oxide is Li_{6.4}La₃Zr_{1.4}Ta_{0.6}O₁₂. In embodiments, the improved performance comprises an increase in conductivity and a decrease in decrease in interfacial resistance.

Aspects of the disclosure are drawn towards a solid-state electrolyte processed by a method described herein.

Aspects of the disclosure are drawn towards an atmospheric plasma discharge device comprising a plasma discharge source surrounded by a shroud, wherein the shroud comprises a shroud gas inlet.

Aspects of the invention are drawn towards a perovskite material produced by the methods described here. For example, the material is a perovskite solar cell. Other objects and advantages of this invention will become readily apparent from the ensuing description.

### BRIEF DESCRIPTION OF THE FIGURES

FIG. 1 shows a non-limiting, exemplary schematic of custom-built shroud enclosing the open-air plasma nozzle with shroud gas injection for cooling after plasma treatment while maintaining a locally inert environment.

FIG. 2 shows non-limiting, exemplary high resolution XPS C is spectra of LLZTO pellet sample at three distinct instances: (panel a) initially following a two-day exposure of the LLZTO surface to ambient air, resulting in the formation of surface Li₂CO₃; (panel b) immediately after in situ Ar⁺ sputtering in the XPS vacuum chamber was performed on the LLZTO surface to remove Li₂CO₃; and (panel c) after three minutes of exposure to ambient following Li₂CO₃ removal by Ar⁺ sputtering.

FIG. 3 shows non-limiting, exemplary C is spectra of the LLZTO surface captured before (on top) and after (on bottom) exposure to open-air plasma for varying durations: (panel a) 5 minutes, (panel b) 10 minutes, (panel c) 20 minutes, and (panel d) 40 minutes. Each treatment time was performed on a different pellet.

FIG. 4 shows a non-limiting Nyquist plot of the LLZTO pellet measured in a pouch cell observed after 2 days of ambient air exposure and after open-air plasma treatment for 20 min.

FIG. 5 shows non-limiting, exemplary images of blown arc discharge open-air plasma nozzle with tunable gas temperature achieved by controlling the ionization gas flow rate from 50 LPM (<100° C.) to 15 LPM (>1500° C.). Temperature measurements were conducted using a Type K thermocouple fixed directly under the nozzle in the low-temperature case and by referencing the color of the metal in the high-temperature case since it was above the melting point of a Type K thermocouple (1260° C.).

FIG. 6 shows a non-limiting, exemplary schematic of sequential steps involved in the treatment of LLZO pellets using open air plasma. It includes: (i) preheating of the plasma jet nozzle to prepare for treatment, and (ii) the steps involved in exposing the pellets to open air plasma.

FIG. 7 shows non-limiting, exemplary XPS C 1s peak fitting results of the spectra show in FIG. 2, showing the atomic concentration analysis of the C═O group associated with Li₂CO₃, C—C, and C—O—C components, at three instances: (a) after two-day exposure to ambient air and before Ar⁺ sputtering, (b) after Ar⁺ sputtering, and (c) after 3 minutes of exposure to ambient subsequent to the Ar⁺ sputtering. The combined atomic concentration of these C is components results in the total carbon percentages presented in Table 2.

FIG. 8 shows non-limiting, exemplary high-resolution O is XPS spectra of LLZTO pellet: (panel a) initially following a two-day exposure of the LLZTO surface to ambient air, resulting in the formation of surface Li₂CO₃; (panel b) immediately after in situ Ar⁺ sputtering carried out in the XPS to remove surface Li₂CO₃; and (panel c) after 3 minutes of exposure to ambient immediately following the Li₂CO₃ removal by Ar⁺ sputtering. The O is feature at lower binding energies to the Li₂CO₃ peak could be made from metal-oxygen bonds in LLZTO (e.g., La—O, Zr—O, Ta—O).

FIG. 9 shows non-limiting, exemplary high-resolution Li 1s and Zr 4s XPS spectra of LLZTO pellet: (panel a) initially following a two-day exposure of the LLZTO surface to ambient air, resulting in the formation of surface Li₂CO₃; (panel b) immediately after in situ Ar⁺ sputtering carried out in the XPS to remove surface Li₂CO₃; and (panel c) after 3 minutes of exposure to ambient immediately following the Li₂CO₃ removal by Ar⁺ sputtering

FIG. 10 shows non-limiting, exemplary wide scan XPS spectra of LLZTO pellet: (panel a) initially following a two-day exposure of the LLZTO surface to ambient air, resulting in the formation of surface Li₂CO₃; (panel b) immediately after in situ Ar⁺ sputtering carried out in the XPS to remove surface Li₂CO₃; and (panel c) after three minutes of exposure to ambient immediately following the Li₂CO₃ removal by Ar⁺ sputtering.

FIG. 11 shows non-limiting, exemplary XPS C is peak fitting results of the spectra in FIG. 3, showing the reduction in atomic concentrations of Li₂CO₃, C—C and C—O—C surface contaminants in LLZTO pellets after open-air plasma treatment durations of (panel a) 5, (panel b) 10 and (panel c) 20 min. Each plasma treatment was carried out on different pellets and the C is peak fitting results for the pellet before the treatment is shown for comparison.

FIG. 12 shows non-limiting, exemplary XPS wide scans obtained after open-air plasma treatment durations of (panel a) 5, (panel b) 10, (panel c) 20 and (panel d) 40 min. The highest presence of Mg contamination, which we attribute to the MgO crucible used as substrate for the LLZTO pellets, is observed after the 40-minute treatment. This is indicated by the increased intensities of the Mg KLL, 2s, and 2p characteristic spectral lines.

FIG. 13 shows a non-limiting, exemplary high resolution C is XPS spectra obtained from LLZTO pellets that were subjected to 10 min open-air plasma treatment and then cooled using different shroud gases. On the left side of the figure, panels (a) and (b) show the LLZTO surface before and after plasma exposure, respectively, followed by post-treatment cooling with oxygen (O₂) as the shroud gas. On the right side, panels (c) and (d) show the surface before and after plasma treatment, respectively, but this time cooled using nitrogen (N₂) as the shroud gas.

FIG. 14 shows a non-limiting, exemplary XPS C1s fitting results, showing the reduction in atomic concentrations of Li₂CO₃, C—C and C—O—C surface contaminants in LLZTO pellets achieved through identical open air plasma treatments of 10 minutes at 20 liters per minute, followed by cooling with different shroud gases: (panel a) oxygen (O₂) versus (panel b) nitrogen (N₂).

FIG. 15 shows non-limiting, exemplary (panel a) Comparison of powder XRD patterns obtained for LLZTO pellet after manually polishing, after subsequent exposure to air for 2 days, and after 20 min open-air plasma treatment and cooling with N₂ shroud gas, compared to reference patterns for LLZTO (PDF card: 04-018-9024) and La₂Zr₂O₇ (01-085-6855). (panel b) Enlarged XRD pattern of LLZTO after plasma treatment compared to references to cubic Li₂O (04-00-4917), cubic MgO (01-080-4192), monoclinic ZrO₂ (04-015-6852), hexagonal Mg₄Ta₂O₉ (00-014-0681), and rhombohedral Li₇TaO₆ (04-010-7805); matching reflections are indicated with tick marks of the same color as the reference pattern. The (110) reflection from monoclinic Li₂CO₃ (00-022-1141) is indicated with the asterisk (*) and the reflections from LLZTO are indicated with the crosses (+).

FIG. 16 shows a non-limiting, exemplary optical images. The top panel shows (a) laser and (b) optical images of the LLZO pellet prior to 20 minutes of plasma treatment. Similarly, the bottom panel shows (c) laser and (d) optical images of the LLZO pellet following 20 minutes of plasma treatment. After the plasma treatment, shroud gas (N₂) flowed at 43 lpm for 5 minutes to cool the samples post treatment.

FIG. 17 shows a non-limiting, exemplary high resolution C is XPS spectra of LLZTO pellets exposed for 2 days indicating comparable levels of Li₂CO₃ levels. The pellet in panel (a) was subsequently subjected to open-air plasma treatment on one face while the pellet in panel (b) was not further treated or polished prior to application of the Li/Sn electrodes for the EIS measurements shown in FIG. 4

FIG. 18 shows non-limiting, exemplary fitting parameters for the EIS data in FIG. 4. For the plasma treated pellet, the impedance at frequencies >300 kHz is taken to represent the total (bulk and grain boundary) contribution to the ionic conductivity while impedance at lower frequencies is the interface resistance with the Li/Sn contacts (including both the plasma treated pellet face and the untreated pellet face). For the untreated pellet, the interface resistance dominated the impedance spectrum and the LLZTO ionic conductivity could not be determined.

### DESCRIPTION OF THE INVENTION

Non-limiting descriptions of one or more embodiments are provided herein. It is to be understood, however, that the invention can be embodied in various forms. Therefore, specific details disclosed herein are not to be interpreted as limiting, but rather as a basis for the claims and as a representative basis for teaching one skilled in the art to employ the invention in any appropriate manner.

The singular forms “a”, “an” and “the” include plural reference unless the context clearly dictates otherwise. The use of the word “a” or “an” when used in conjunction with the term “comprising” in the claims and/or the specification can mean “one,” but it is also consistent with the meaning of “one or more,” “at least one,” and “one or more than one.”

Wherever any of the phrases “for example,” “such as,” “including” and the like are used herein, the phrase “and without limitation” is understood to follow unless explicitly stated otherwise. Similarly, “an example,” “exemplary” and the like are understood to be nonlimiting.

The term “substantially” allows for deviations from the descriptor that do not negatively impact the intended purpose. Descriptive terms are understood to be modified by the term “substantially” even if the word “substantially” is not explicitly recited.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b and c. Wherever the terms “a” or “an” are used, “one or more” is understood, unless such interpretation is nonsensical in context.

As used herein, the term “about” can refer to approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower). In embodiments, the term “about” can be denoted by “˜”.

As used herein, the term “substantially the same” or “substantially” can refer to variability typical for a particular method is taken into account.

The terms “sufficient” and “effective”, as used interchangeably herein, can refer to an amount (e.g., mass, volume, dosage, concentration, and/or time period) needed to achieve one or more result(s).

Before explaining at least one embodiment of the disclosure in detail, it is to be understood that the disclosure is not necessarily limited in its application to the details set forth in the following description or exemplified by the examples. The disclosure can be used for other embodiments or of being practiced or carried out in various ways. Other compositions, compounds, methods, features, and advantages of the disclosure will be or become apparent to one having ordinary skill in the art upon examination of the following drawings, detailed description, and examples. All such additional compositions, compounds, methods, features, and advantages can be included within this description, and be within the scope of the disclosure.

Aspects of the disclosure are drawn towards methods of removing Li₂CO₃ from a lithium-ion solid-state electrolyte material to improve material performance comprising: exposing a lithium-ion solid-state electrolyte material to an atmospheric plasma discharge for an exposure period, thereby removing Li₂CO₃; terminating the atmospheric plasma discharge exposure; thereby producing a solid-state electrolyte with improved material performance. In embodiments, the method can further comprise flowing a shroud gas over the material.

As used herein, the terms “atmospheric plasma discharge” and “open-air plasma” can be used interchangeably. As used herein, the term “atmospheric plasma discharge” can refer to thermal or non-thermal plasmas. For example, thermal atmospheric plasma discharge can comprise high-intensity arc discharges and plasma torches. For example, the non-thermal atmospheric plasma discharge can comprise corona discharges, atmospheric pressure glow discharges, dielectric barrier discharges, and blown arc discharges. For example, the plasma discharge can be a blown arc discharge non-thermal plasma is used.

In embodiments, the exposure period comprises less than about 1 second to greater than about 1 hour. For example, the exposure period comprises about 0.5 seconds, about 1.0 seconds, about 1.5 seconds, about 2 seconds, about 2.5 seconds, about 3 seconds, about 3.5 seconds, about 4 seconds, about 4.5 seconds, about 5 seconds, about 5.5 seconds, about 6 seconds, about 6.5 seconds, about 7 seconds, about 7.5 seconds, about 8 seconds, about 9 seconds, 10 seconds, about 15 seconds, about 20 seconds, about 25 seconds, about 30 seconds, about 35 seconds, about 40 seconds, about 45 seconds, about 50 seconds, about 1 minute, about 2 minutes, about 3 minutes, about 4 minutes, about 5 minutes, about 6 minutes, about 7 minutes, about 8 minutes, about 9 minutes, about 10 minutes, about 11 minutes, about 12 minutes, about 13 minutes, about 14 minutes, about 15 minutes, about 16 minutes, about 17 minutes, about 18 minutes, about 19 minutes, about 20 minutes, about 21 minutes, about 22 minutes, about 23 minutes, about 24 minutes, about 25 minutes, about 27 minutes, about 30 minutes, about 33 minutes, about 35 minutes, about 37 minutes, about 40 minutes, about 43 minutes, about 45 minutes, about 47 minutes, about 50 minutes, about 53 minutes, about 55 minutes, about 57 minutes, about 60 minutes, or greater than 60 minutes.

In embodiments, the atmospheric plasma discharge is open to ambient air or is contained within an enclosure providing a controlled atmosphere. As used herein, the term “ambient air” can refer to atmospheric air and/or air comprising about 75% to about 80% nitrogen, about 20% to about 25% oxygen, about 0% to about 1% argon, and about 0% to about 0.1% CO₂. As used herein, the term “controlled atmosphere” can refer to an atmosphere where the composition of gases is controlled. For example, a controlled atmosphere can comprises about 0 to about 100% of nitrogen, oxygen, argon, or any combination thereof.

In embodiments, the plasma discharge is a non-thermal blown-arc plasma discharge. As used herein, the term “non-thermal” plasma discharge can refer to an ionized gas that is generated by an electrical discharge at atmospheric pressure. For example, the term “non-thermal blown-arc discharge” can refer to a plasma source created using compressed gas as an ionization source delivered into a high voltage electrode with a grounded internal wall to generate an arc that is blown out of a nozzle. For example, the material can be treated through exposure to the afterglow or after zone of the plasma discharge. In embodiments, the afterglow or after zone can be quasineutral. The quasinuetral nature can be due to the direct charge transfer occurring over the Debye length scale, which is on the sub-millimeter scale at atmospheric pressure. Without wishing to be bound by theory, the ion densities of atmospheric pressure plasma sources are at an even lower concentration because ions are heavier than electrons and have an even shorter mean free path.

In embodiments, the plasma discharge temperature comprises a temperature of less than about 100° C. to about 3000° C. For example, the temperature can comprise less than about 50° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., about 200° C., about 225° C., about 250° C., about 275° C., about 300° C., about 325° C., about 350° C., about 375° C., about 400° C., about 425° C., about 450° C., about 475° C., about 500° C., about 525° C., about 550° C., about 575° C., about 600° C., about 625° C., about 650° C., about 675° C., about 700° C., about 725° C., about 750° C., about 775° C., about 800° C., about 825° C., about 850° C., about 875° C., about 900° C., about 925° C., about 950° C., about 975° C., about 1000° C., about 1025° C., about 1050° C., about 1075° C., about 1100° C., about 1120° C., about 1130° C., about 1140° C., about 1150° C., about 1160° C., about 1170° C., about 1180° C., about 1190° C., about 1200° C., about 1225° C., about 1250° C., about 1275° C., about 1300° C., about 1325° C., about 1350° C., about 1375° C., about 1400° C., about 1425° C., about 1450° C., about 1475° C., about 1500° C., about 1525° C., about 1550° C., about 1575° C., about 1600° C., about 1625° C., about 1650° C., about 1675° C., about 1700° C., about 1725° C., about 1750° C., about 1775° C., about 1800° C., about 1825° C., about 1850° C., about 1875° C., about 1900° C., about 1925° C., about 1950° C., about 1975° C., about 2000° C., about 2025° C., about 2050° C., about 2075° C., about 2100° C., about 2125° C., about 2175° C., about 2200° C., about 2225° C., about 2250° C., about 2275° C., about 2300° C., about 2325° C., about 2350° C., about 2375° C., about 2400° C., about 2425° C., about 2450° C., about 2475° C., about 2500° C., about 2525° C., about 2550° C., about 2575° C., about 2600° C., about 2625° C., about 2650° C., about 2675° C., about 2700° C., about 2725° C., about 2750° C., about 2775° C., about 2800° C., about 2825° C., about 2850° C., about 2875° C., about 2900° C., about 2925° C., about 2950° C., about 2975° C., about 3000° C., or greater than about 3000° C.

In embodiments, the atmospheric plasma discharge has an ionization gas flow rate of about 15 to about 50 lpm. For example, the ionization gas flow can comprise less than about 5 lpm, about 5 lpm, about 10 lpm, about 15 lpm, about 16 lpm, about 17 lpm, about 18 lpm, about 19 lpm, about 20 lpm, about 21 lpm, about 22 lpm, about 23 lpm, about 24 lpm, about 25 lpm, about 26 lpm, about 27 lpm, about 28 lpm, about 29 lpm, about 30 lpm, about 31 lpm, about 32 lpm, about 33 lpm, about 34 lpm, about 35 lpm, about 36 lpm, about 37 lpm, about 38 lpm, about 39 lpm, about 40 lpm, about 41 lpm, about 42 lpm, about 43 lpm, about 44 lpm, about 45 lpm, about 46 lpm, about 47 lpm, about 48 lpm, about 40 lpm, about 50 lpm, or greater than 50 lpm.

In embodiments, the atmospheric plasma discharge source is at a distance of less than about 0.5 mm to greater than about 10 mm from the material during the exposure period. For example, the distance can comprise about 0.25 mm, about 0.5 mm, about 1 mm, about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, about greater than about 20 mm.

Non-limiting, surprising aspects of the disclosure comprise the incorporation of a shroud around the plasma discharge source and the use of a shroud gas to prevent additional reactions of the material surface while cooling after plasma discharge exposure. Described herein, we have modified the atmospheric plasma discharge with a shroud addition enveloping the nozzle. Without wishing to be bound by theory, this can generate higher fluxes and allow more intense surface reactions/chemical modifications since most of the reactive species have energies greater than typical molecular bond energies. This can allow for the ability to drive chemical reactions at surfaces that are less feasible with other plasma sources while maintaining low temperature and while ensuring that atmospheric species do not cause side reactions for the solid-state electrolyte during the treatment. In embodiments, the shroud and shroud gas can generate a locally controlled environment while operating in ambient.

As used herein, the term “shroud gas” can refer to gas that is directed through and/or contained by a shroud. In embodiments, the shroud gas is selected from N₂, O₂, Ar, or a combination thereof. In embodiments, the shroud gas can be flowed over the material at a rate of about 5 lpm to about 1000 lpm. For example, the shroud gas flow rate can comprise less than about 5 lpm, about 5 lpm, about 10 lpm, about 15 lpm, about 16 lpm, about 17 lpm, about 18 lpm, about 19 lpm, about 20 lpm, about 21 lpm, about 22 lpm, about 23 lpm, about 24 lpm, about 25 lpm, about 26 lpm, about 27 lpm, about 28 lpm, about 29 lpm, about 30 lpm, about 31 lpm, about 32 lpm, about 33 lpm, about 34 lpm, about 35 lpm, about 36 lpm, about 37 lpm, about 38 lpm, about 39 lpm, about 40 lpm, about 41 lpm, about 42 lpm, about 43 lpm, about 44 lpm, about 45 lpm, about 46 lpm, about 47 lpm, about 48 lpm, about 40 lpm, about 50 lpm, about 55 lpm, about 60 lpm, about 70 lpm, about 80 lpm, about 90 lpm, about 100 lpm, or greater than about 100 lpm.

In embodiments, the lithium-ion solid-state electrolyte is a lithium lanthanum zirconium oxide (LLZO) (Li₇La₃Zr₂O₁₂). In embodiments, the lithium lanthanum zirconium oxide further comprises one or more dopants known in the art (see e.g., Raju et al., Electrochem 2021, 2(3), 390-414). For example, the dopants can be selected from the group consisting of Al, Ga, Nb, Ta, Ca, Fe, Y, Si, Gd, Ge, Sb, Zn, Nd, W, and Te. For example, the dopants can comprise Ca²⁺, Fe^{2+/3+}, Zn²⁺, Al³⁺, Ga³⁺, Y³⁺, Si⁴⁺, Gd⁴⁺, Ge⁴⁺, Nb⁵⁺, Ta⁵⁺, Sb⁵⁺, W⁶⁺, Nd⁵⁺, and Te⁶⁺. In embodiments, the material can have 1, 2, or 3 dopants. For example, the LLZO material can comprise LLZO-AₐB_{b}C_{c}, wherein A, B, and C are independently selected from a dopant known in the art. For example, LLZO-AₐB_{b}C_{c}, wherein A, B, C are independently selected from Al, Ga, Nb, or Ta, and wherein 0≤a≤3, 0≤b≤3, and 0≤b≤3.

In embodiments, the oxide solid state electrolyte can comprise Lithium Lanthanum Zirconium Oxide (LLZO), lithium Lanthanum Zirconium Gallium Oxide (LLZGO), ALLZO, NbLLZO and Lithium Lanthanum Zirconium Tantalum Oxide (LLZTO).

In embodiments, the Al-doped LLZO can be LiₓLa_{y}Zr_{z}Al_{w}O₁₂, wherein 5≤x≤9, 2≤y≤4, 1≤z≤3, 0≤w≤1. In embodiments, the lithium lanthanum zirconium oxide is Li_{6.4}La₃Zr_{1.4}Ta_{0.6}O₁₂, Li_{6.25}Al_{0.25}La₃Zr₂O₁₂, Li_{6.4}Nb_{0.5}La₃Zr_{1.5}O₁₂, or Li_{5.5}La₃Zr₂Ga_{0.5}O₁₂.

For example, the lithium lanthanum zirconium oxide is Li_{6.4}La₃Zr_{1.4}Ta_{0.6}O₁₂.

In embodiments, the improved performance can comprise an increase in conductivity and a decrease in decrease in interfacial resistance.

Aspects of the disclosure are drawn towards a solid-state electrolyte processed by any method described herein. In embodiments, the solid-state electrolytes processed by the methods described herein can be used for battery applications. For example, this can include high energy density batteries for consumer electronics to electric vehicles, UAVs, drones, satellites, energy for refrigeration, residential, commercial, and eventually grid-scale energy storage.

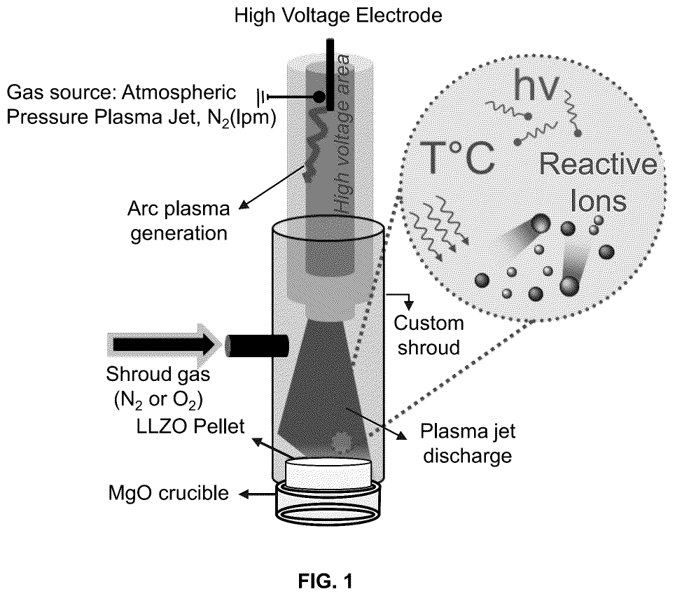

Aspects of the disclosure are drawn towards an atmospheric plasma discharge device comprising a plasma discharge source surrounded by a shroud, wherein the shroud comprises a shroud gas inlet. A non-limiting, exemplary schematic of the device is shown in FIG. 1. In embodiments, the shroud can be made from a high temperature material as known in the art. For example, the shroud can be made from stainless steel.

### Example 1

Surface Reduction of Li₂CO₃ on LLZTO Solid-State Electrolyte Via Scalable Open-Air Plasma Treatment

### Non-Limiting Summation

Described herein is the use of an atmospheric pressure, open-air plasma treatment to remove Li₂CO₃ species from the surface of garnet-type tantalum-doped lithium lanthanum zirconium oxide (Li_{6.4}La₃Zr_{1.4}Ta_{0.6}O₁₂, LLZTO) solid-state electrolyte pellets. The Li₂CO₃ layer, which we show forms on the surface of garnets within 3 minutes of exposure to ambient moisture and CO₂, increases the interface (surface) resistance of LLZTO. The plasma treatment is carried out entirely in ambient and is enabled by use of a custom-built metal shroud that is placed around the plasma nozzle to prevent moisture and CO₂ from reacting with the sample. After the plasma treatment, N₂ compressed gas is flowed through the shroud to cool the sample and prevent atmospheric species from reacting with the LLZTO. We demonstrate that this approach is effective for removing the Li₂CO₃ from the surface of LLZTO. The surface chemistry is characterized with X-ray photoelectron spectroscopy to evaluate the effect of process parameters (such as plasma exposure time, ionization gas flow rate, and shroud gas chemistry) on removal of the surface species. We also show that the open-air plasma treatment can significantly reduce the interface resistance. This platform demonstrates a path towards open-air processed solid-state batteries.

### INTRODUCTION

Successful synthesis of cubic lithium lanthanum zirconium oxide (c-LLZO) by Murugan et. al in 2007 marked an important milestone in the advancement of garnet-based solid-state electrolytes (SSEs) [1]. Most notably, c-LLZO stands out due to its unique combination of properties, including high Li-ion conductivity at room temperature (˜1 mS cm⁻¹), low activation energy (0.3 eV), excellent oxidation stability at high voltages, and chemical stability against several electrode materials, which is rare among discovered SSEs [2-5]. Ta-doping to form LLZTO has been used more recently to provide the critical Li vacancy concentration needed to stabilize c-LLZO [6, 7].

Integrating LLZO into solid-state batteries (SSBs) to match the electrochemical performance of traditional Li-ion batteries using liquid electrolytes presents numerous challenges[8,9]. One significant obstacle is the spontaneous formation of Li₂CO₃ on the surface of LLZO upon exposure to moisture and CO_{2 [10, 11}]. The mechanism of this reaction is well-documented [12-15]. This process removes Li from the bulk LLZO structure, resulting in a Li-deficient LLZO phase beneath a newly formed Li₂CO₃ layer [16], which could lead to decreased ionic conductivity. Surface Li₂CO₃ also causes poor contacts at the Li/LLZO interface, resulting in decreased Li-ion transport and higher interface impedance[17,18]. Moreover, Li₂CO₃ accumulated in the LLZO grain boundaries tends to reduce to electronically conductive LiCₓ during electrochemical cycling, accelerating the transition of Li ions into Li dendrites [19]. Additionally, phase inhomogeneity caused by Li₂CO₃ at the electrode-electrolyte interface can result in inferior mechanical properties of the materials and interfaces [20, 21].

The effect of Li₂CO₃ on compromising the mechanical, electrochemical, and safety performance of SSBs has been extensively examined in previous work [15, 22-26]. Therefore, removing surface Li₂CO₃ from LLZO SSEs emerges as a crucial approach to ensuring optimal electro/chemo/mechanical and safety performance of SSBs. Current methods for removing Li₂CO₃ include mechanical polishing, use of inorganic additives, and thermal treatments under Ar atmosphere, which are time-consuming and difficult to scale up [27-35]. In contrast to this, previous research has demonstrated that scalable, faster processing steps, such as exposure to atmospheric pressure (open-air) plasma, can be effective for contamination removal, activation, and deposition on metal, ceramic, and polymeric surfaces [36-39]. In this work, we investigate the use of an atmospheric pressure (open-air) plasma to remove surface Li₂CO₃ formed on LLZO pellets.

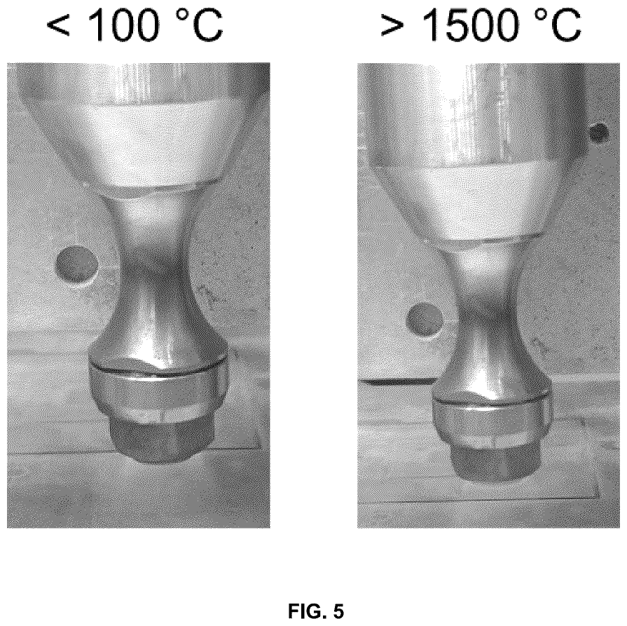

Open-air plasma technology offers a unique opportunity for surface treatments and functionalization by driving reactions and changes to surfaces that are not possible with other plasma or modification approaches [40,41]. The uniqueness of the open-air plasma system is the combination of energy sources which are generated: electrons and reactive species (radicals, metastables, and photons) are produced in combination with convective heat to rapidly transfer energy to enable ultrafast precursor conversion or post-treatment. The blown-arc discharge, open-air plasma configuration used in this work has 3 key unique features: (1) Potential-free discharge: The plasma discharge is virtually electrically neutral, and the substrate remains free from the electric field of the discharge zone based on a nozzle design that limits the arc discharge [42-44]. This allows for treatment of metals along with electrically sensitive materials, semiconductors, and non-conductive materials. (2) Tunable gas temperature: The electron temperatures in open-air plasmas are usually very high, reaching values >10,000° C. [45]. As a result, chemical reactions that take place at high temperatures can be reached (driven by electrons) with significantly reduced heat at values ranging from near-room temperature to ˜1,500° C. (FIG. 5). The open-air plasma system in this work offers an advantage over conventionally used RF or microwave plasmas because of the opportunity to rapidly transform materials at such a wide and controllable temperature range. (3) Configurability to tune energy fluxes and reactive species: Previous work has shown that changing the nozzle head design can be used to tune the energy flux onto a treated surface [46]. For example, the combination of convective heat along with reactive species has been shown to accelerate the curing of halide perovskite materials above that which can be achieved for the same amount of treatment with compressed gas heated to the same temperature of the plasma [47].

This work includes the addition of an external shroud that was designed to enable injection of externally supplied compressed gas into the region surrounding the plasma. This would allow for displacement of the ambient air molecules and enable the use of a shroud gas after the plasma treatment for cooling of the samples back to room temperature. A schematic representation of the key components of the open-air plasma system, including the custom external shroud, is provided in FIG. 1.

The use of N₂ shroud gas for cooling samples post open-air plasma treatment, facilitated by the external shroud, can play a pivotal role in preventing specific reactions that can lead to the reformation of surface Li₂CO₃ on the LLZTO surface. One such reaction is the increased likelihood of CO₂ adsorption, especially at temperatures exceeding 450° C. [48]. While the adsorption of O₂ on the LLZTO surface is less probable at lower temperatures, higher temperatures create a high-energy surface that can accelerate Li₂CO₃ reformation via Li₂O intermediate [49]. Furthermore, temperatures above 600° C. can increase the mobility of Li ions, allowing them to penetrate and cross the existing Li₂CO₃ shell on the LLZTO surface, thus promoting the formation of additional Li₂CO₃ layers [50,51]. Thus, by using an external shroud that directs N₂ post open-air plasma treatment, the surface temperature of LLZTO can be kept below 400° C., which can effectively prevent the conditions for the formation of additional Li₂CO₃ via the aforementioned routes.

Described herein is the combination of open-air plasma exposure and cooling via shroud gas can be tuned effectively to remove Li₂CO₃ from the surface of lithium-ion materials, such as LLZTO pellets, in an ambient environment. This removal is quantified through surface chemistry characterization and validated with impedance spectroscopy measurements.

### 2. Materials and Methods

### 2.1 LLZTO Pellet Preparation

Ta-doped pyrochlores were synthesized through a non-aqueous sol-gel process, detailed in our earlier research, to serve as precursors for LLZTO in a method called pyrochlore-to-garnet (P2G) [52,53]. The nominal composition of the LLZTO is Li_{6.4}La₃Zr_{1.4}Ta_{0.6}O₁₂. Initially, metal-organic precursors dissolved in propionic acid were combusted at 850° C. for two hours, forming pyrochlore. Subsequently, this material was ball-milled with LiOH, incorporating a 25 mol % excess of Li, and then formed into pellets under a uniaxial pressure of approximately 300 MPa using a SpecAc press. Finally, these pellets were sintered at 1100° C. for 2 h in MgO crucibles within a Li₂O-rich atmosphere in a tube furnace (Lindberg/BlueM TF55030A) with Al₂O₃ tubes and a heating rate of 5° C./min. The sintering process is described in detail in our previous work [52, 54].

The relative density of the pellets post-sintering were determined through measurements of weight, thickness, and cross-sectional area, then compared to a theoretical density of 5.4 g/cm³ [55]. Crystal structure analysis was performed using a powder diffractometer (Malvern PANalytical Aeris, CuKα source). The formation of the LLZTO cubic phase was verified by comparing the powder X-ray diffraction (XRD) pattern of the pellets with the LLZTO reference pattern from PDF card 04-018-9024 [56]. The pellets in this study typically featured a cross-section area of approximately 35 mm² and a thickness ranging from 0.5-0.7 mm.

### 2.2. Open-Air Plasma Conditions

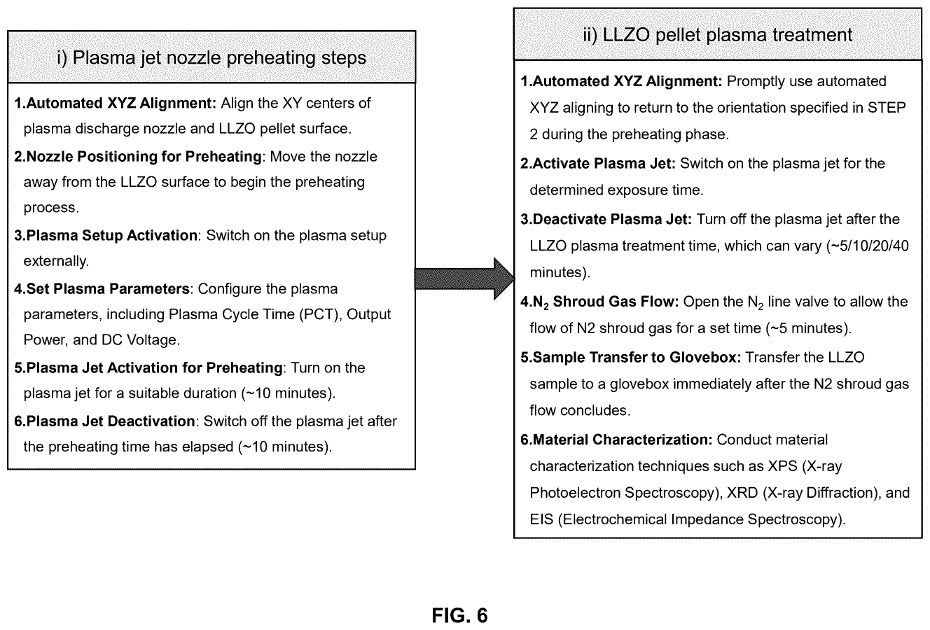

Open-air plasma treatment on LLZTO pellets to remove surface Li₂CO₃ was carried out using a Plasmatreat Open-air® Plasma Generator. This system has been shown to be compatible with a range of materials and device structures in previous work [47]. The LLZTO pellets were placed on MgO crucibles serving as substrates during the plasma treatment. The varied plasma conditions in this study included exposure time and the shroud gas environment post-plasma exposure (N₂ or 02). FIG. 6 outlines the steps for preheating and exposing the LLZO pellet to an open-air plasma jet. All treatments had 100% plasma cycle time (duty cycle). The plasma output power, generator DC voltage, and high voltage transformer current are not directly controlled and remained between 630-645 W, 270-280 V, and 11-12 A, respectively. The N₂ ionization gas flow rate was also kept constant at 20 liters per minute (lpm) and the distance between the plasma nozzle and the LLZTO pellet was set at 1 mm. Shroud gas (N₂ or 02) flow was used for post-plasma treatment cooling with flow rate kept at 43 lpm for 5 minutes.

### 2.3. Materials Characterization

X-ray photoelectron spectroscopy (XPS) was used to analyze the elemental composition and surface chemistry of the LLZTO samples using a Kratos Axis Supra+ spectrometer equipped with a monochromatic Al Kα X-ray source. The surface morphology of LLZO pellets before and after plasma treatment was characterized using a Keyence VHX-7000 Optical Microscope. The as-sintered pellets were manually polished in ambient conditions with a series of SiC sandpapers (240 to 2000 grit, McMaster-Carr) to achieve flat surfaces. Then, the pellets were left out in ambient conditions (RH˜38%-43%) for 2 days to form a uniform Li₂CO₃ layer, and thereafter subjected to plasma treatment. Following plasma treatment, the samples were quickly transferred to a glovebox filled with an N₂ atmosphere within 30 seconds to 1 minute. Inside the N₂ glove box, the plasma-treated samples were mounted onto a transfer sample holder provided by Kratos, which can maintain a vacuum created by a mechanical pump. This setup ensured that during transport of the sample holder to the XPS main chamber, the plasma-treated samples remained sealed from the external environment, allowing for an effective evaluation of the impact of open-air plasma treatment on surface Li₂CO₃ reduction. Consequently, the exposure of the LLZTO surface to ambient conditions after open-air plasma treatment is limited to around 30 seconds to 1 minute prior to XPS analysis. For comparison, some LLZTO samples were subjected to Ar⁺ sputtering inside the XPS with 20 keV 500 Ar⁺ ion clusters (equivalent to 40 eV Ar⁺ ions, a process designed not to reduce the elements in the sample [52]). All measured XPS binding energies were calibrated to the C is hydrocarbon (C—C) peak at 285 eV [57, 58].

The high-resolution Li is, 0 is, and C is spectral peak components were fitted with CasaXPS software[59]. Backgrounds for these components were quantified using a Shirley-type subtraction method that adjusts to changes in the spectral data, ensuring accurate background computation [60,61]. Additionally, Kratos sensitivity factors specific to the XPS instrument used in this study were applied to enhance the fitting accuracy [61].

To fit peak components in the high-resolution Li, O, and C is spectra, we used the Gaussian-Lorentzian sum function GL(x), which represents symmetric XPS signals [62]. In general, the full width at half-maximum (FWHM) of these high-resolution Li is, O is, and C 1s spectral peak components was restricted to values less than 2 eV, as specified in the literature [63,64]. The FWHM for the C═O (Li₂CO₃) and C—C components in the C 1s spectra was limited to 1.1-1.3 eV [65,66]. Meanwhile, for the C—O—C components, the FWHM was allowed to vary between 1.0-1.5 eV [66]. For the O 1s spectra, the FWHM for the Li₂CO₃ and metal oxide(s) components was set to 1.4-1.7 eV [63,65,66]. Similarly, the FWHMs of the Li₂CO₃ and Li—O components were allowed to vary between 1.0-1.5 eV for the Li is spectra [64,67]. In this study, the mixing parameter, a is 0.7. Thus, the line shape GL(x) becomes GL(30)=[0.3·L(x)]+[0.7·L(x)] for XPS signals [65]. Previous literature provides detailed equations for the Gaussian and Lorentzian components, as well as for the FWHM, half width at half maximum (HWHM), and other related parameters[62].

### 2.4. Electrochemical Impedance Spectroscopy (EIS) Measurements

EIS measurements were conducted at room temperature using a Biologic SP-200 potentiostat, spanning a frequency range from 7 MHz to 1 Hz with a 50 mV stimulus voltage. These measurements assessed the interfacial resistance of LLZTO pellets under two distinct conditions: i) after exposure to ambient atmosphere for 2 days, and ii) after open-air plasma treatment.

For the latter condition, following plasma treatment, LLZTO pellets were exposed to either O₂ or N₂ shroud gas for 5 minutes at 43 lpm to cool the sample surface below 200° C. LLZTO pellets for both conditions were then promptly transferred to an Ar-filled glovebox with minimal exposure to ambient air (approximately 30 seconds to 1 minute). Inside the Ar glovebox, the pellets were vacuum-sealed in heat-sealable polybags. After vacuum sealing, these pellets were moved to another Ar glovebox, where low impedance electrical contacts made of a nonblocking Li/Sn alloy (comprising 20 wt. % or approximately 1.5 mol % Sn) were applied to both sides of each LLZO pellet, creating a layer approximately 100 m thick, following procedures outlined in previous studies [52,54]. After application of the Li/Sn electrical contacts, copper (Cu) wires were connected to them and the pellet was enclosed in a heat sealable polybag, such that only the Cu wires were extending out. These extended Cu wires were connected to the potentiostat for EIS measurements as described in our prior work [68,69]. The impedance data were fit as described in our previous work [70].

### 3. Results and Discussion

3.1. Li₂CO₃ Formation Kinetics

The spontaneous formation of Li₂CO₃ on the surface of garnets has been reported extensively. Following mechanical polishing under inert atmosphere, Sharafi et al. observed the reappearance of the C═O peak associated with Li₂CO₃ on the surface of LLZTO after 7 minutes of air exposure [71]. However, it is not clear if the Li₂CO₃ levels were measured before polishing, or if the same sample was used to characterize the C is spectrum after polishing and air exposure [71]. Apart from this report, there is a limited body of literature exploring the rapidity with which Li₂CO₃ reforms on the LLZTO surface post ambient air exposure. Most studies investigating the detrimental effects of Li₂CO₃ on LLZTO ionic conductivity have utilized longer exposure times, ranging from 15 min to as long as 90 days, as indicated in Table 1. Therefore, the formation kinetics of Li₂CO₃ on LLZTO discussed here hopefully provide some new understanding to the community.

TABLE 1
Shows literature reports on the adverse effects of Li₂CO₃ on LLZO ionic
conductivity after exposure to ambient air for different times.

| | | | | Ionic | Ionic | |
|---|---|---|---|---|---|---|
| | | | | conductivity | conductivity | |
| | | | Air | before air | after air | |
| | Air | | RH | exposure | exposure | |
| Type of LLZO | exposure | | (%) | (S/cm) | (S/cm) | References |
| Li_{6.5}La₃Zr_{1.5}Ta_{0.5}O₁₂ | 42 | days | 80 | 6.45*10⁻⁴ | 3.61*10⁻⁴ | [1] |
| Pellet | | | | | | |
| Li_{6.75}La₃Zr_{1.75}Al_{0.25}O₁₂ | 90 | days | — | 1.81*10⁻⁶ | 2.39*10⁻⁵ | [2] |
| (Sintered in Alumina | | | | | | |
| Crucible) | | | | | | |
| Li_{6.5}La₃Zr_{1.5}Nb_{0.5}O₁₂ | 22 | days | — | 7*10⁻⁴ | 2.25*10⁻⁴ | [3], [4] |
| Li₇La₃Zr₂O₁₂ | 5 | days | 70 | 2.09*10⁻⁵ | 2.48*10⁻⁵ | [5] |
| Li_{6.85}La₃Zr_{1.85}Ga_{0.15}O₁₂ | 15 | min | — | 8*10⁻⁴ | 2*10⁻⁶ | [6] |
| Li_{6.85}La₃Zr_{1.85}Ga_{0.15}O₁₂ | 30 | min | — | 8*10⁻⁴ | 4.8*10⁻⁶ | |

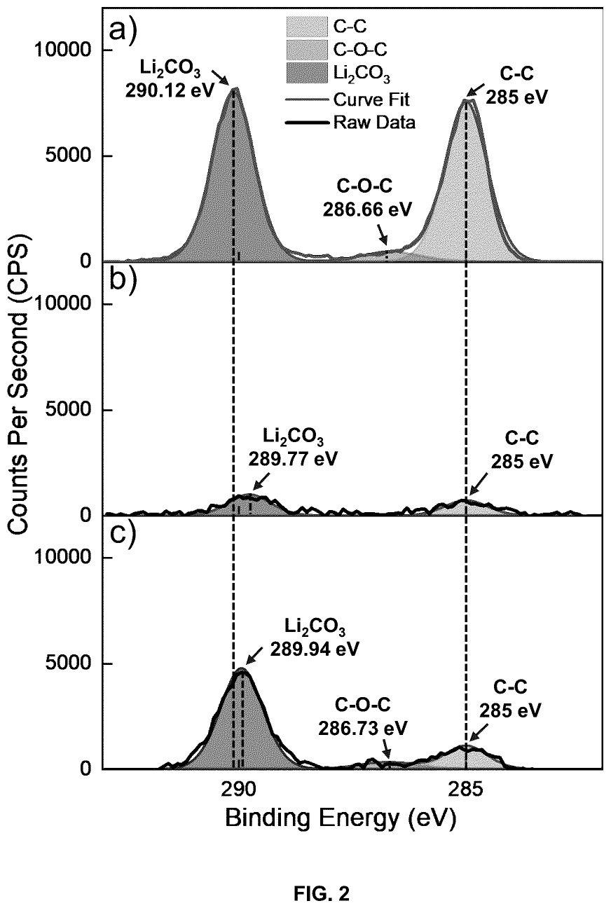

FIG. 2 panels (a-c) shows the high-resolution XPS C is spectra obtained on the same LLZTO pellet at three different conditions. FIG. 2 panel (a) shows the spectrum taken following a two-day exposure of the LLZTO surface to ambient air, which results in the formation of surface Li₂CO₃. This pellet was then transferred to the NIPS as described in Sec. 2.3 and subjected to in situ Ar⁺ sputtering to remove the surface Li₂CO₃. The resulting C 1s spectrum is shown in FIG. 2 panel (b). After the Ar⁺ sputtering, the pellet was re-exposed to ambient conditions for 3 minutes, and then measured again with NIPS at the identical location, resulting in the spectrum shown in FIG. 2 panel (c).

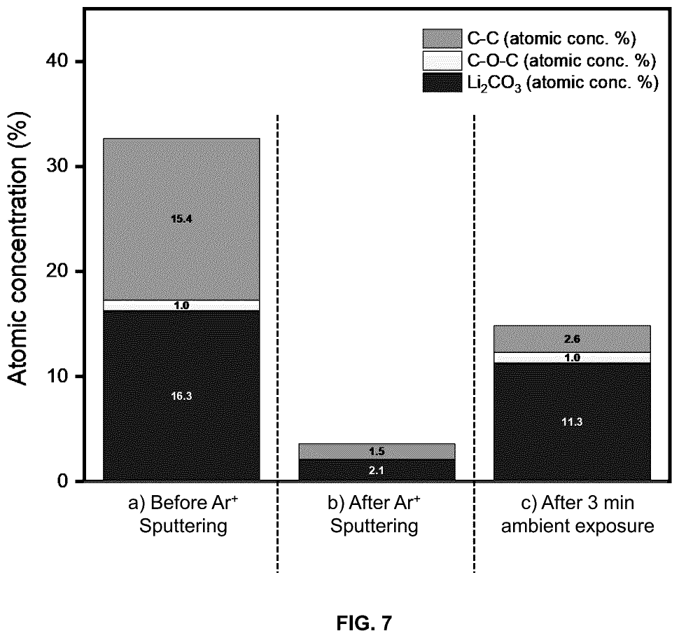

Table 2: Shows analyses of overall atomic concentration of Li, C, O, La, Ta, and Zr signals determined by NPS for LLZTO pellet at three different conditions (after 2-days exposure to air, after in situ Ar⁺ sputtering, and after exposure to ambient air for 3 min after Ar⁺ sputtering). Detailed peak fitting and deconvolution of the C is spectra are shown in FIG. 2 and FIG. 7.

Before in situ Ar⁺ Sputtering (After 2 days of air exposure)

| C (%) | Li (%) | O (%) | La (%) | Ta (%) | Zr (%) |
|---|---|---|---|---|---|
| 32.67 | 25.47 | 41.87 | — | — | — |

After in situ Ar⁺ Sputtering

| C (%) | Li (%) | O (%) | La. (%) | Ta (%) | Zr (%) |
|---|---|---|---|---|---|
| 3.59 | 24.3 | 59.14 | 8.75 | 1.17 | 3.06 |

After 3 min exposure to ambient air

| C (%) | Li (%) | O (%) | La (%) | Ta (%) | Zr (%) |
|---|---|---|---|---|---|
| 14.84 | 30.81 | 48.22 | 3.98 | 0.71 | 1.45 |

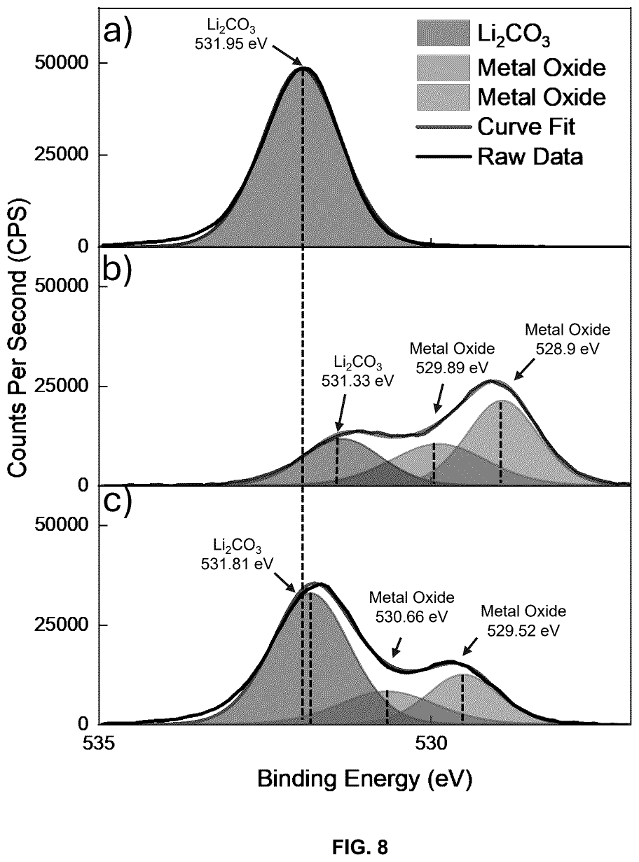

Table 2 provides the overall atomic concentrations of Li, C, O, La, Ta, and Zr measured on the LLZTO pellets surfaces for all three instances shown in FIG. 2 panels (a-c), while FIG. 7 shows the atomic concentration analysis from the C is peak fitting to C═O associated with Li₂CO₃, C—C, and C—O—C for the same cases. Additionally, the corresponding high-resolution O 1s and Li is spectra are shown in FIG. 8 panels (a-c) and 9 panels (a-c), respectively. The C is peaks observed at 290.12 eV in FIG. 2(a) and 289.94 eV in FIG. 2(c) correspond to the C═O peak at ˜290 eV, widely reported for Li₂CO₃ present on the surface of LLZO-based SSEs in the literature [11, 33, 72, 73]. There is a slight shift in the C═O peak in FIG. 2(b) to 289.77 eV, which is unexpected and could be due to the uncertainty in aligning the binding energies to the significantly reduced C—C feature after sputtering. However, this slight shift in binding energy is still within the binding energy values reported for the C═O peak originating from Li₂CO₃ reported elsewhere [72,74]. The C is atomic concentration associated with Li₂CO₃ (C═O) intensity diminishes from 16.3% to 2.1% after Ar⁺ sputtering but increases to 11.3% when the LLZTO sample surface is re-exposed to ambient air for a three-minute period, as indicated by respective C is atomic concentrations shown in FIG. 7.

The O 1s spectra shown in FIG. 8 panels (a-c) exhibit a clear correlation with the corresponding C is spectra in FIG. 2(a-c). As illustrated in FIG. 8 panel (a), following a two-day exposure to ambient, the O is spectrum of the LLZTO surface primarily a peak at 531.95 eV attributed to Li₂CO₃, with no clear indication of signals associated with the metal oxide bonding in the lattice of the underlying LLZTO. In contrast, the O is spectrum of the LLZTO surface immediately after Ar⁺ sputtering, as shown in FIG. 8 panel (b), indicates the presence of both Li₂CO₃ and metal-oxide bonding in LLZTO. These O is peaks at binding energies associated with Li₂CO₃ and LLZTO lattice are consistent with those reported in the literature for LLZO [53, 75-77].

After Ar⁺ sputtering, the binding energy for the O is peak at 531.95 eV associated with Li₂CO₃ on the LLZTO surface shifts to 531.33 eV as the thickness of the Li₂CO₃ layer is reduced. This decrease in the binding energy of the O is peak for Li₂CO₃ could be attributed to the interaction of the remaining Li₂CO₃ layer with the underlying LLZTO phase, which can consist of surface states or defects capable of donating electrons and reducing the existing Li₂CO₃ layer.

The O 1s peak observed on the LLZTO surface after a 3-minute ambient exposure, as shown in FIG. 8 panel (c), is at 531.81 eV, which is very close to the O 1s peak binding energy observed on LLZTO after two days of exposure to ambient air. The signal from the LLZTO lattice is also observed in this case. The largest difference in binding energy between the O 1s peaks associated with Li₂CO₃ and metal-oxide is around 2.3-2.4 eV, as illustrated in FIG. 8 panels (b) and (c), which is comparable to the O 1s binding energy difference for Li₂CO₃ and metal-oxide peak positions that have been previously reported [53, 77].

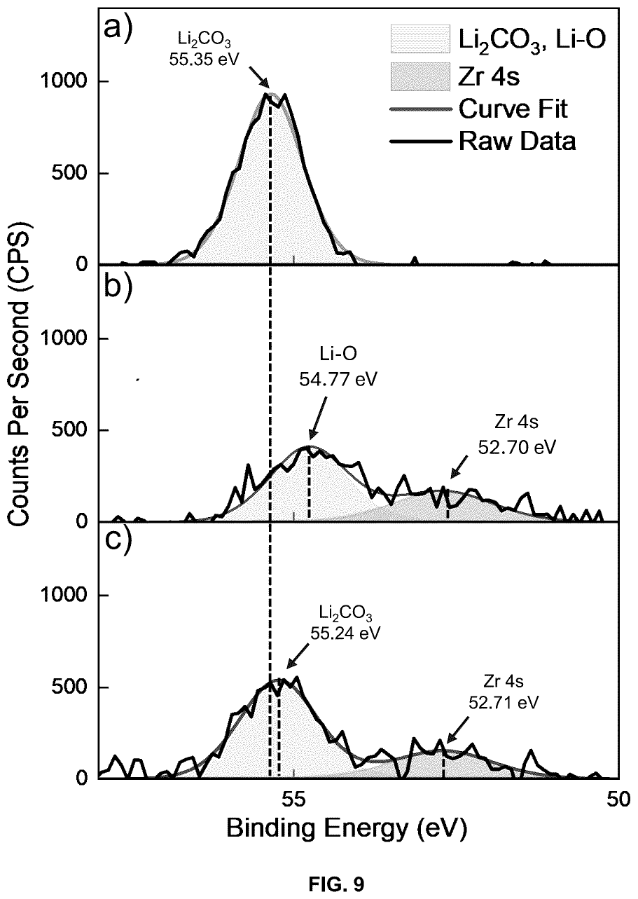

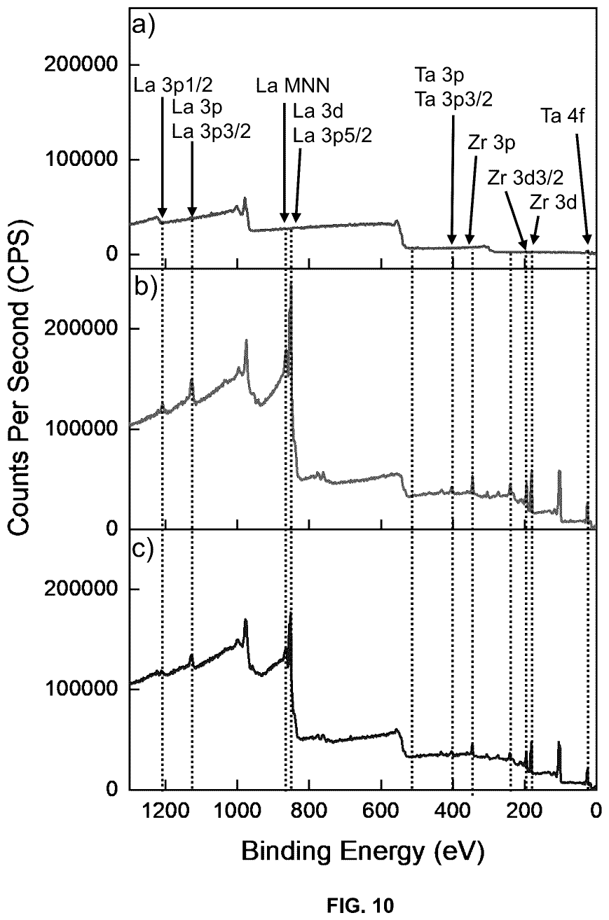

FIG. 9 panels (a-c) presents the high-resolution Li is spectra corresponding to the cases described in FIG. 2 panels (a-c). As illustrated in FIG. 9 panels (a) and (c), the Li is peaks at 55.35 eV and 55.24 eV can be attributed to Li₂CO₃ [78]. Conversely, the Li is peak at 54.77 eV observed after Ar⁺ sputtering is attributable to Li—O in LLZTO [79]. Furthermore, FIG. 9 panels (b) and (c) reveal peaks at around 52.70 and 52.24 eV, respectively, which can be attributed to Zr 4s. FIG. 10 panels (a-c) shows the corresponding wide scans for each of the cases in FIG. 2 panels (a-c). FIG. 10 panels (b) and (c) clearly show the presence of La, Zr, and Ta, which are associated with the LLZTO phase. These data confirms that the Ar⁺ sputtering can remove the Li₂CO₃ surface species and reveal the underlying LLZTO, but that Li₂CO₃ can reform and partially cover the LLZTO surface again upon exposure to ambient air after only three minutes.

3.2. Effect of Open-Air Plasma Treatment on Reduction of Surface Li₂CO₃ on LLZTO

The open-air plasma can drive surface chemical reactions through the control of the combination of heat and reactive species from the plasma processing parameters. Specifically, we focus on 2 parameters: treatment time (5, 10, 20 or 40 minutes) and shroud gas chemistry (N₂ or 02) used after treatment.

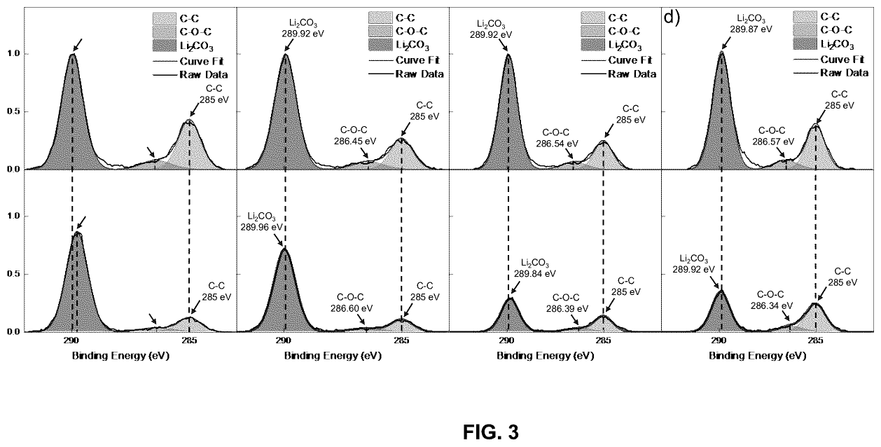

The effect of open-air plasma treatment was carried out on LLZTO pellets that were initially exposed to ambient air for 2 days prior to the treatment. Each pellet was subjected to different plasma treatment times and the XPS measurement was carried out on the same pellet before and after the treatment, although different pellets were used for each treatment time. FIG. 3 panels (a-d) shows the C is spectra before and after plasma treatment durations of (a) 5, (b) 10, (c) 20, and (d) 40 minutes with N₂ ionization gas. The N₂ shroud gas was turned on and flowed for 5 minutes after each plasma treatment. FIG. 3 panels (a-d) presents the normalized peak intensities, which were computed by dividing the values by the greatest intensity measured in counts per second, of each pellet before the plasma treatment.

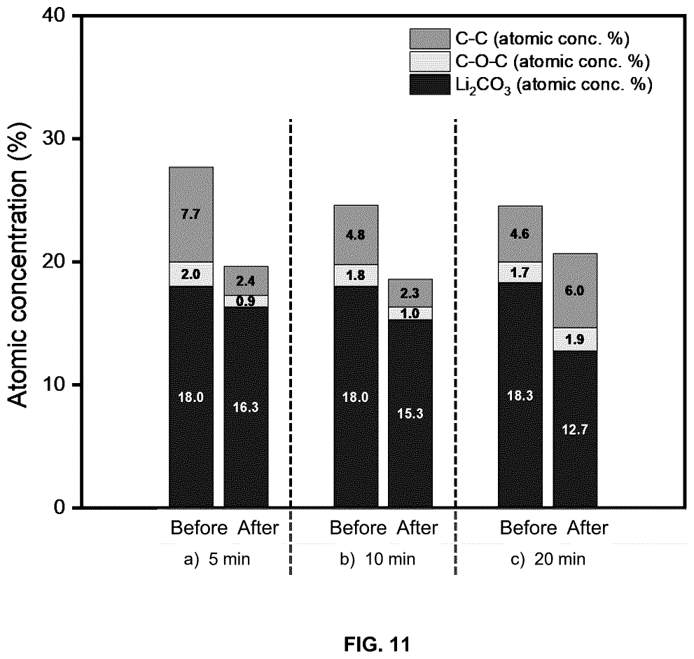

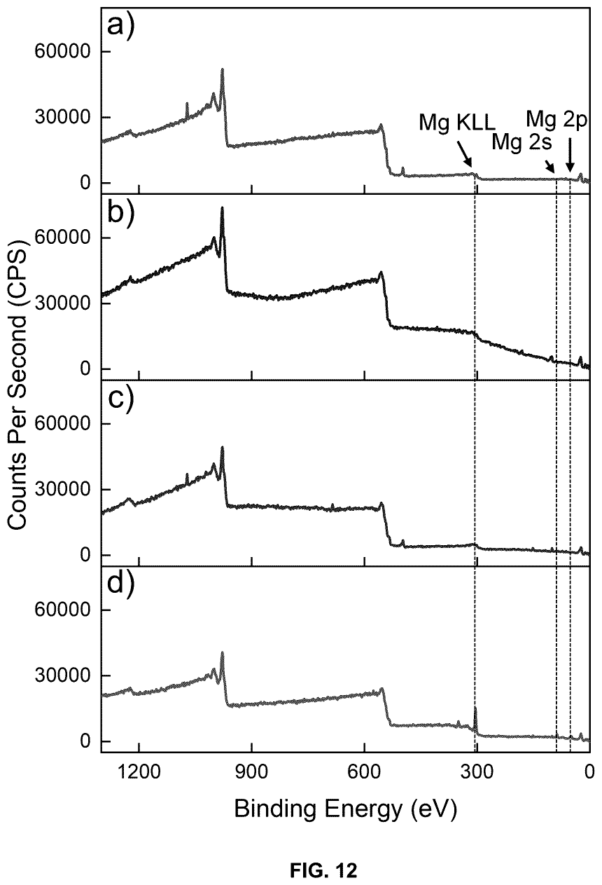

The XPS results showed that all treatment times studied were effective in reducing surface Li₂CO₃ from LLZTO, but the most significant reduction occurs after exposure to open-air plasma for 20 and 40 minutes, as indicated in FIG. 3 panels (c) and (d), showing a decreased intensity C═O peak intensity associated with Li₂CO₃ for both treatments. FIG. 11 presents the C is peak fitting results before and after the open-air plasma treatment, revealing a 31% decrease in Li₂CO₃ (C═O) peak intensity after 20 minutes. Estimation of C is atomic concentration associated with Li₂CO₃ after 40 minutes was not very accurate due to the observation of Mg contamination in the sample. This contamination is visible in FIG. 12, which shows a higher intensity of Mg KLL, 2s, and 2p characteristic spectral lines following the 40-minute treatment in the XPS wide scan. The source of Mg contamination is most likely from the MgO substrate used to support the LLZTO pellet during the plasma treatment.

Interestingly, while the reduction of Li₂CO₃ levels observed for the sample exposed to open-air plasma for 20 minutes exceeds that of samples exposed for 5 and 10 minutes, shorter exposure times result in a greater reduction of adventitious carbon (C—C), evident by comparing the peak intensity at 285 eV in FIG. 3 panels (a) and (b). FIG. 11 shows that the decrease in atomic concentration associated with adventitious carbon (C—C) after 5 and 10 minutes of open-air plasma exposure is 70% and 52%, respectively. Similarly, FIG. 11 shows that shorter durations of open-air plasma exposure (5 and 10 minutes) result in a greater reduction of C is atomic concentration associated with C—O—C than longer durations of open-air plasma exposure (20 minutes), in accordance with the observed trend for C—C reductions. Thus, there is a clear indication that longer exposure durations, beginning at 5 minutes, lead to an increase in the magnitude of Li₂CO₃ reduction, whereas the magnitude of C—C and C—O—C reduction decreases over the same durations. Finally, in terms of Li₂CO₃ levels, comparing the results in FIG. 11 panel (c) with those in FIG. 7 panel (c) indicates that LLZTO surfaces after 20 minutes of open-air plasma exposure are similar to those seen after a 3-minute exposure to ambient conditions following Ar⁺ sputtering.

3.3. Influence of Shroud Gas on Surface Reduction of Li₂CO₃ on LLZTO

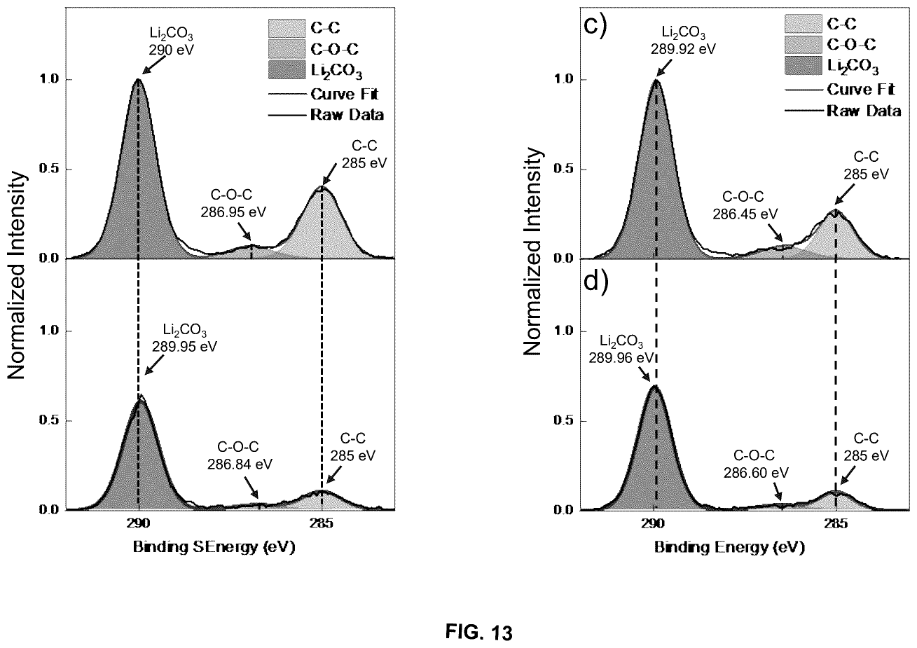

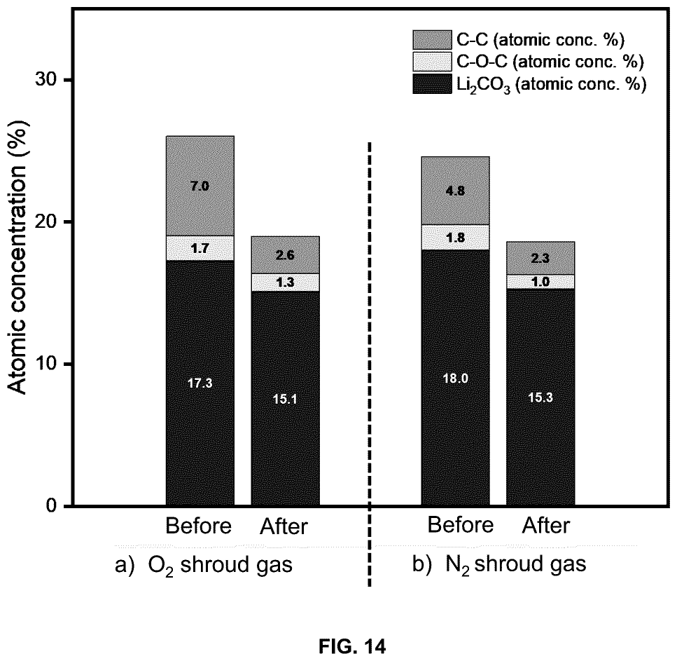

FIG. 13 panels (a-d) shows the normalized C is spectra from LLZTO surfaces through four panels, before and after plasma treatment with post-treatment using 02 or N₂ as shroud gas. Both of these cases underwent 10-minute open-air plasma treatments with an ionization gas (N₂) flow rate of 20 lpm prior to cooling. The results in FIG. 13 panels (a-b) show that using O₂ as the shroud gas results in a minimal shift in the Li₂CO₃ peak from 290 eV to 289.95 eV. However, FIG. 13 panels (c-d) shows that using N₂ as the shroud gas causes no shift in the Li₂CO₃ peak, indicating no further chemical reduction of Li₂CO₃ induced by the N₂ shroud gas. Peak fitting results shown in FIG. 14 indicate that using 02 and N₂ as shroud gases reduces the C is atomic concentration associated with Li₂CO₃ (C═O) by 13% and 15%, and C is atomic concentration associated with C—C by 63% and 52%, respectively. Thus, the choice of O₂ or N₂ shroud gas for cooling may not significantly affect the efficacy of removing surface contaminants like adventitious carbon (C—C) and Li₂CO₃.

### 3.4 Effect of Open-Air Plasma Treatment on LLZTO Crystal Structure and Surface Morphology

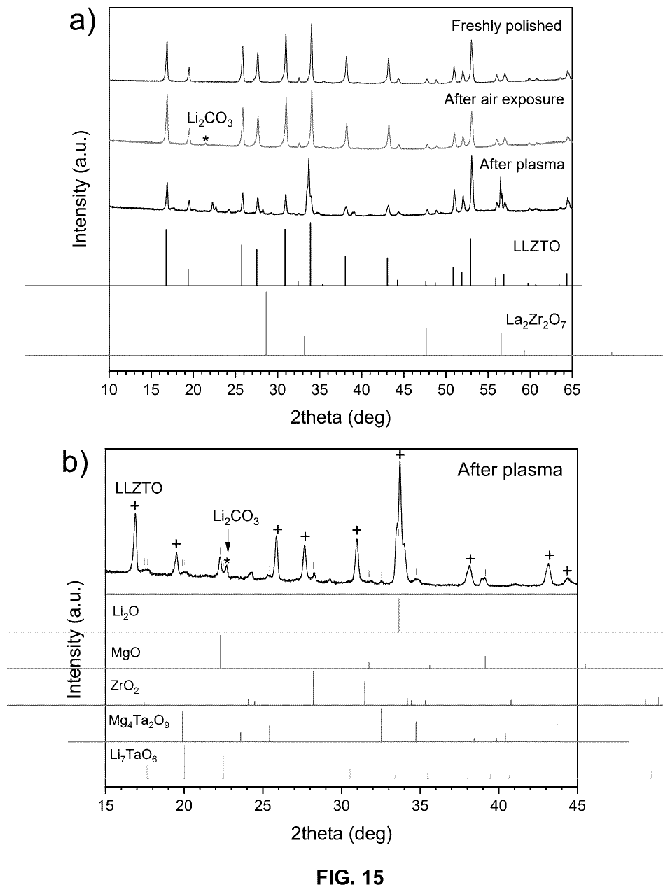

FIG. 15 panel (a) shows a comparison of powder XRD patterns obtained for an LLZTO pellet manually polished with sandpaper and subjected to minimal air exposure, after the polished pellet was exposed to air for 2 days, and then after the pellet was subjected to open-air plasma treatment for 20 min, followed by cooling with N₂ shroud gas. All three XRD patterns showed reflections matching the LLZTO reference. The XRD pattern for the pellet after 2 days air exposure had a small peak at 20-21.5°, which corresponds to the (110) reflections of Li₂CO₃ but was otherwise unchanged from the XRD pattern of the freshly polished sample. After the plasma treatment, the XRD results show that the LLZTO structure remained intact, with no indication of phases that form because of Li-loss, such as pyrochlore (La₂Zr₂O₇). However, close inspection of the XRD pattern for the plasma treated sample shows the presence of several impurity phases such as Li₂O, MgO, ZrO₂, Mg₄Ta₂₀₉, and Li₇TaO₆, as shown in FIG. 15 panel (b). The minor amount of MgO is consistent with the minor Mg signal observed in the XPS measurements (FIG. 12), and is attributed to contamination from the MgO crucible. Therefore, without wishing to be bound by theory, contamination can be mitigated by incorporating a sacrificial LLZO material as the crucible, for example LLZTO. Further, without wishing to be bound by theory, the crucible can be selected from another high temperature ceramic material. For example, the crucible can comprise Al₂O₃, ZrO₂, and/or SiO₂. Nonetheless, the results shown in FIG. 15 indicate the effectiveness of the open-air plasma treatment for reducing the Li₂CO₃ surface content without causing deleterious effects to the LLZTO structure, and therefore other Li-ion materials.

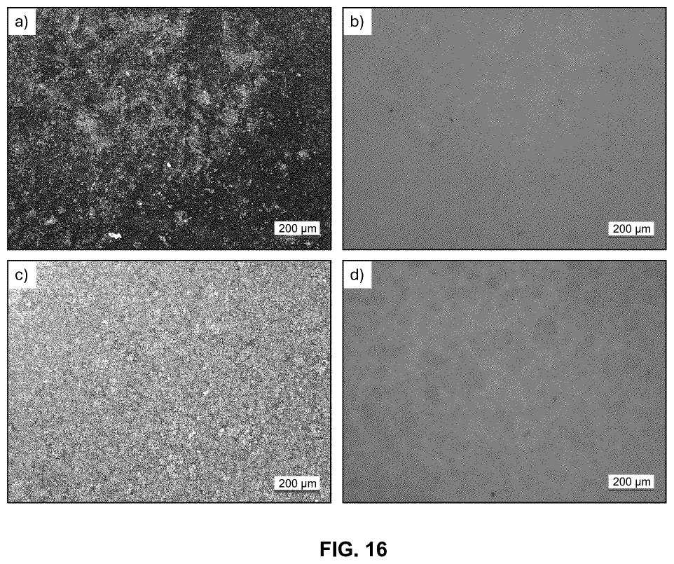

FIG. 16 panels (a-d) shows the surface morphology of an LLZO pellet before and after 20 minutes of open-air plasma exposure, followed by a 5-minute cooling phase with shroud gas (N₂). FIG. 16 panels (a) and (c) show laser images of the LLZO pellet surface before and after plasma treatment, respectively. The laser image after the treatment shows a significantly smoother surface topography, as evidenced by a 36% reduction in overall surface height (Sa), as shown in Table 3. However, the optical images in FIG. 16 panels (b) and (d), taken before and after plasma treatment, respectively, do not show any significant differences. The decrease in surface roughness parameter is consistent with the etching of the surface layer from the LLZTO pellets during the open-air plasma treatment.

TABLE 3
Shows a comparison of surface roughness parameter,
Sₐ (Arithmetic Mean Height), before and after
20-minute open-air plasma treatment.

| Surface roughness | Before Plasma | After Plasma | Reduction |
|---|---|---|---|
| parameter | Treatment | Treatment | in Sₐ (%) |
| Sₐ (Arithmetic | 10.62 μm | 6.75 μm | 36 |
| Mean Height) | | | |

### 3.5. Effect of Open-Air Plasma Treatment on Interface Resistance and Ionic Conductivity

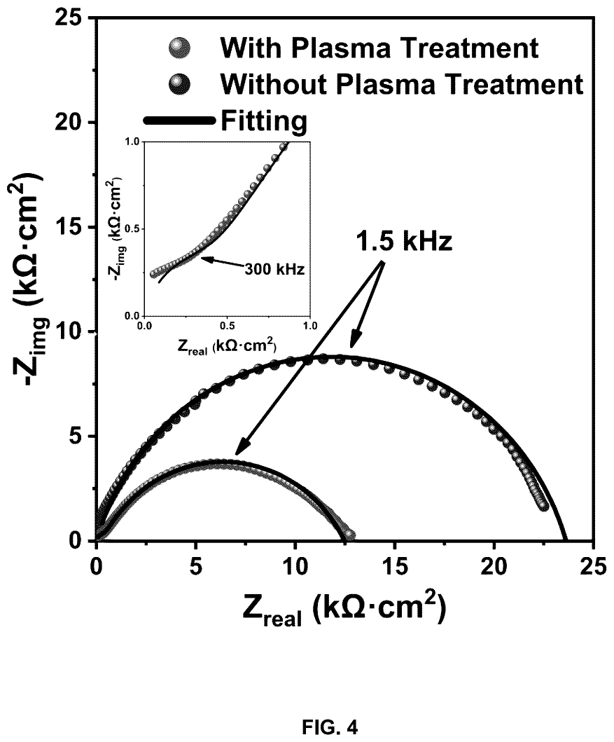

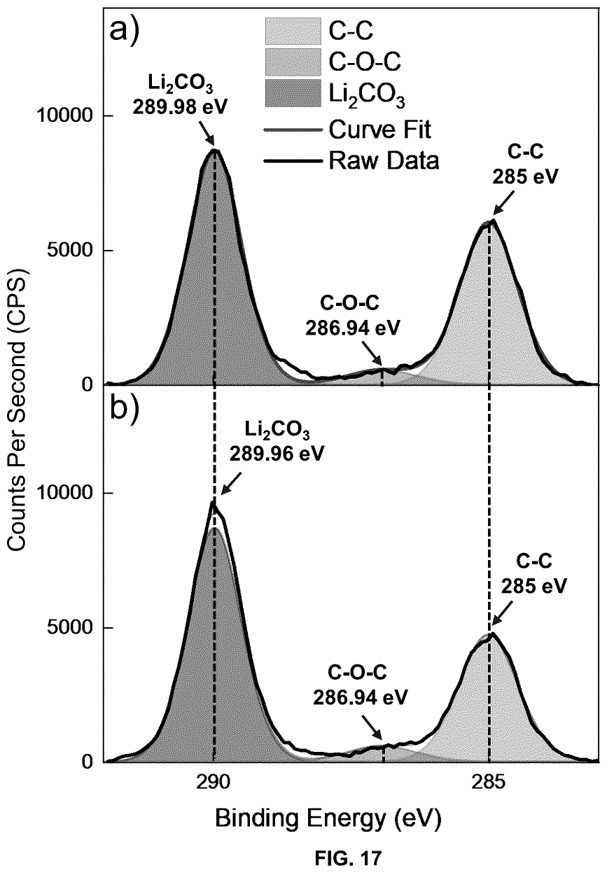

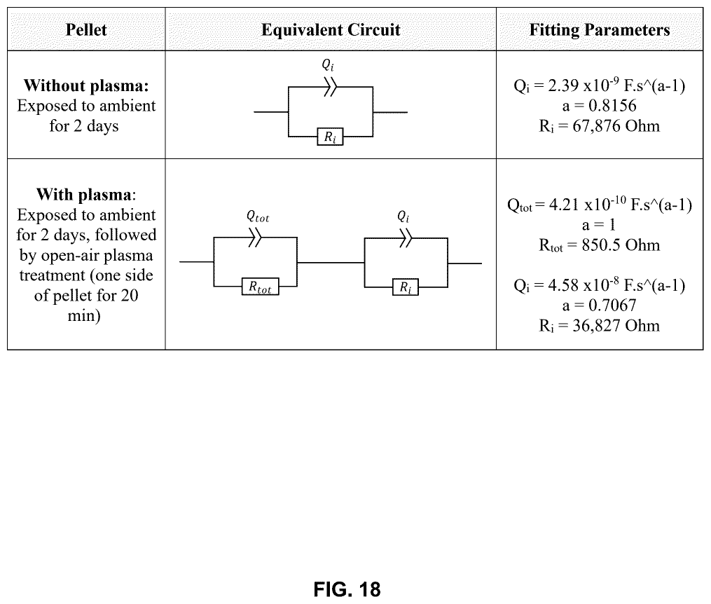

To examine the impacts of the open-air plasma treatment on the LLZTO interface resistance, we prepared symmetric cells comprising LLZTO pellets contacted with nonblocking electrodes made from Li/Sn alloy. Two pellets were exposed to ambient atmosphere for two days and the XPS spectra (FIG. 17) confirmed they had similar levels of surface Li₂CO₃. Then, a 20 min plasma treatment was performed on one of the pellets (one face only). FIG. 4 shows the Nyquist plot obtained for the plasma treated pellet had a much lower impedance than the one without plasma treatment. The EIS data for the plasma treated pellet could be fit with an equivalent circuit of Qₜₒₜ/Rₜₒₜ+Qᵢ/Rᵢ where Rₜₒₜ is the total (bulk and grain boundary) resistance, Rᵢ is the interface resistance, and Qₜₒₜ and Qᵢ are constant phase elements to account for nonideal capacitance (see FIG. 18 for fitting parameters). From this fitting, the total ionic conductivity of the plasma-treated LLZTO was determined to be 0.14 mS/cm and the interface resistance was ˜37 kOhm (12.5 kOhm·cm²). This ionic conductivity value is consistent with our previous observations for pellets with similar relative density of ˜78% [53]. Without the plasma treatment, the EIS data could not be fit to the same equivalent circuit because the interface impedance dominated the Nyquist plot. Using Qᵢ/Rᵢ for the equivalent circuit, the resistance was determined to be ˜68 kOhm (22.4 kOhm·cm²), or almost double the interfacial resistance seen in the sample that was subjected to open-air plasma treatment. The overall interface resistance of the treated pellet is still fairly high, but it is important to note that only one side of the LLZTO pellet was exposed to the plasma. As such, it is likely that Li₂CO₃ on the bottom interface of the pellet greatly increased the interfacial resistance of the measurement. This is a further reason supporting the efficacy of such an approach for LLZTO thin films (i.e., such as those that might be used in anode-free SSBs), where the bottom interface will be bonded to a current collector and protected from atmospheric species.

The observed reduction in interfacial resistance achieved through open-air plasma treatment (approximately 44%) is compared to other reported treatments in Table 4. The reduction is less than that achieved by heating LLZO at 250° C. for 1 h under an inert atmosphere (approximately 70%), a method used to reintegrate Li components from Li₂CO₃ back into LLZO [80,81]. Qualitatively, the heating method significantly reduces the amount of Li₂CO₃ on the LLZTO surfaces, although the degree of reduction was not quantified in the literature for this method. When compared to this method, the open-air plasma treatment has advantages such as not requiring an inert environment and requiring less time to achieve reductions in Li₂CO₃ surface species.

TABLE 4
Shows a comparison between the open-air plasma treatment
used in this study and existing methods for Li₂CO₃.

| | Interfacial | | Interfacial | | | |
|---|---|---|---|---|---|---|
| | resistance | | resistance | | | |
| Li₂CO₃ removal | without | | with | | Reduction | |
| method | treatment | | treatment | | (%) | References |
| Heating at 250° C. for 1 h | 607 | Ω-cm² | 178 | Ω-cm² | 70.7 | [7] |
| in an Ar environment | | | | | | |
| Heating at 900° C. for 1 h | 9.1 | kΩ-cm² | 55 | Ω-cm² | 99.4 | [8] |
| in an Ar environment | | | | | | |
| Addition of 2% LiF | 1260 | Ω-cm² | 645 | Ω-cm² | 48.8 | [9] |
| inorganic additives | | | | | | |
| Open-air plasma | 22.4 | kΩ-cm² | 12.5 | kΩ-cm² | 44 | This work |

treatment (one side of
pellet for 20 min)

Another high-temperature thermal cleaning method involves heating at elevated temperatures for several hours in Ar environment. For example, using 900° C. for 1 h leads to reported reduction in interfacial resistance exceeding 99% [82]. Another study showed that a 2-hour treatment of LLZTO at 800° C. in an inert Ar glovebox could greatly help the integration of the SSE into fully operating solid-state Li/S batteries with high sulfur cathode loading[83]. However, this method is not scalable for removing Li₂CO₃ from LLZTO because it requires high temperatures, long treatment times, and an inert environment.

Contrary to conventional thermal cleaning methods, a very promising rapid (˜2 s) thermal pulse treatment reported recently, is also mentioned for Li₂CO₃ reduction. However, its effect on Li₂CO₃ reduction is not as significant as that we observed with the open-air plasma treatment, as evident from the comparison of the C is spectra before and after treatment for both methods [84].

In a separate work, using 2% LiF inorganic additive to the LLZTO provides a slightly lower improvement in interfacial resistance [35]. The advantage of open-air plasma over this method lies in its avoidance of additional complexity in manufacturing and quality control caused by LiF addition. Introducing LiF can demand higher mixing time, and tighter control of LiF particle size and distribution to form a LiF protective layer that can achieve a similar improvement comparable to Li₂CO₃ removal by open-air plasma treatment. Furthermore, as the surface and volume of the electrolyte increase, open-air plasma treatment offers better scalability capabilities through automated systems.

### 4. Non-Limiting Conclusion

Described herein, we show an open-air treatment method to remove Li₂CO₃ and improve the ionic conductivity of LLZTO pellets. In terms of Li₂CO₃ levels, the XPS analysis indicates that LLZTO surfaces after 20 minutes of open-air plasma exposure are similar to those seen after a 3-minute exposure to ambient conditions following Ar⁺ sputtering. Open-air plasma treatments offer considerable benefits. These include, but are not limited to, a significant decrease in interfacial resistance and the capability to scale up and process larger LLZTO surfaces under normal atmospheric conditions. This makes open-air plasma treatments a practical option for removing Li₂CO₃ on lithium ion surfaces, such as LLZTO.

This advancement is the first such report of enabling open-air processability of LLZTO SSEs. Additionally, for thin film SSEs on a substrate, the open-air plasma will be better suited for reducing the overall interface resistance since the bottom side will not experience the same Li₂CO₃ growth as was observed in this work for LLZTO pellets.

### REFERENCES CITED HEREIN

1. Murugan, R.; Thangadurai, V.; Weppner, W. Fast Lithium Ion Conduction in Garnet-type Li7La3Zr2O12. Angewandte Chemie International Edition 2007, 46, 7778-7781.
2. Samson, A. J.; Hofstetter, K.; Bag, S.; Thangadurai, V. A Bird's-Eye View of Li-Stuffed Garnet-Type Li 7 La 3 Zr 2 O 12 Ceramic Electrolytes for Advanced All-Solid-State Li Batteries. Energy Environ Sci 2019, 12, 2957-2975.
3. Xu, L.; Li, J.; Deng, W.; Shuai, H.; Li, S.; Xu, Z.; Li, J.; Hou, H.; Peng, H.; Zou, G. Garnet Solid Electrolyte for Advanced All-solid-state Li Batteries. Adv Energy Mater 2021, 11, 2000648.
4. Jia, M.; Zhao, N.; Huo, H.; Guo, X. Comprehensive Investigation into Garnet Electrolytes toward Application-Oriented Solid Lithium Batteries. Electrochemical Energy Reviews 2020, 3, 656-689.
5. Abouali, S.; Yim, C.-H.; Merati, A.; Abu-Lebdeh, Y.; Thangadurai, V. Garnet-Based Solid-State Li Batteries: From Materials Design to Battery Architecture. ACS Energy Lett 2021, 6, 1920-1941.
6. Thompson, T.; Wolfenstine, J.; Allen, J. L.; Johannes, M.; Huq, A.; David, I. N.; Sakamoto, J. Tetragonal vs. Cubic Phase Stability in Al-Free Ta Doped Li 7 La 3 Zr 2 O 12 (LLZO). J Mater Chem A Mater 2014, 2, 13431-13436.
7. Ma, K.; Chen, B.; Li, C.-X.; Thangadurai, V. Improvement of the Li-Ion Conductivity and Air Stability of the Ta-Doped Li 7 La 3 Zr 2 O 12 Electrolyte via Ga Co-Doping and Its Application in Li—S Batteries. J Mater Chem A Mater 2024, 12, 3601-3615.
8. Wu, Z.; Xie, Z.; Yoshida, A.; Wang, Z.; Hao, X.; Abudula, A.; Guan, G. Utmost Limits of Various Solid Electrolytes in All-Solid-State Lithium Batteries: A Critical Review. Renewable and Sustainable Energy Reviews 2019, 109, 367-385.
9. Oh, P.; Lee, H.; Park, S.; Cha, H.; Kim, J.; Cho, J. Improvements to the Overpotential of All-solid-state Lithium-ion Batteries during the Past Ten Years. Adv Energy Mater 2020, 10, 2000904.
10. Huo, H.; Luo, J.; Thangadurai, V.; Guo, X.; Nan, C.-W.; Sun, X. Li₂CO₃: A Critical Issue for Developing Solid Garnet Batteries. ACS Energy Lett 2019, 5, 252-262.
11. Yi, X.; Guo, Y.; Pan, S.; Wang, Y.; Chi, S.; Wu, S.; Yang, Q.-H. Duality of Li₂CO₃ in Solid-State Batteries. Transactions of Tianjin University 2023, 29, 73-87.
12. Feng, W.; Zhao, Y.; Xia, Y. Solid Interfaces for the Garnet Electrolytes. Advanced Materials 2024, 2306111.
13. Han, S.; Wang, Z.; Ma, Y.; Zhang, Y.; Wang, Y.; Wang, X. Recent Advances in Solving Li2CO3 Problems in Garnet-Based Solid-State Battery: A Systematic Review (2020-2023). Journal of Energy Chemistry 2023.
14. Familoni, O.; Zhou, Y.; Duan, H. Air Stability of LLZO Electrolytes. Solid Electrolytes for Advanced Applications: Garnets and Competitors 2019, 69-89.
15. Wang, J.; Chen, L.; Li, H.; Wu, F. Anode Interfacial Issues in Solid-state Li Batteries: Mechanistic Understanding and Mitigating Strategies. Energy & Environmental Materials 2023, 6, e12613.
16. Hofstetter, K.; Samson, A. J.; Narayanan, S.; Thangadurai, V. Present Understanding of the Stability of Li-Stuffed Garnets with Moisture, Carbon Dioxide, and Metallic Lithium. J Power Sources 2018, 390, 297-312.
17. Wu, J.-F.; Pu, B.-W.; Wang, D.; Shi, S.-Q.; Zhao, N.; Guo, X.; Guo, X. In Situ Formed Shields Enabling Li2CO3-Free Solid Electrolytes: A New Route to Uncover the Intrinsic Lithiophilicity of Garnet Electrolytes for Dendrite-Free Li-Metal Batteries. ACS Appl Mater Interfaces 2018, 11, 898-905.
18. Cheng, L.; Wu, C. H.; Jarry, A.; Chen, W.; Ye, Y.; Zhu, J.; Kostecki, R.; Persson, K.; Guo, J.; Salmeron, M. Interrelationships among Grain Size, Surface Composition, Air Stability, and Interfacial Resistance of Al-Substituted Li7La3Zr₂O₁₂ Solid Electrolytes. ACS Appl Mater Interfaces 2015, 7, 17649-17655.
19. Biao, J.; Han, B.; Cao, Y.; Li, Q.; Zhong, G.; Ma, J.; Chen, L.; Yang, K.; Mi, J.; Deng, Y. Inhibiting Formation and Reduction of Li2CO3 to LiCx at Grain Boundaries in Garnet Electrolytes to Prevent Li Penetration. Advanced Materials 2023, 35, 2208951.
20. 'Yan, G. Mechanical Behavior of Solid Electrolyte Materials for Lithium-Ion Batteries, RWTH Aachen University: Aachen, 2020.
21. Wang, S.; Barks, E.; Lin, P.-T.; Xu, X.; Melamed, C.; McConohy, G.; Nemsak, S.; Chueh, W. Effect of H+ Exchange & Surface Impurities on Bulk & Interfacial Electrochemistry of Garnet Solid Electrolytes. 2024.
22. Yoon, G.; Kim, S.; Kim, J. Design Strategies for Anodes and Interfaces Toward Practical Solid-State Li-Metal Batteries. Advanced Science 2023, 10, 2302263.
23. Ji, W.; Luo, B.; Yu, G.; Wang, Q.; Zhang, Z.; Tian, Y.; Liu, Z.; Ji, W.; Nong, Y.; Wang, X. A Review of Challenges and Issues Concerning Interfaces for Garnet-Type All-Solid-State Batteries. J Alloys Compd 2024, 173530.
24. Miao, X.; Guan, S.; Ma, C.; Li, L.; Nan, C. Role of Interfaces in Solid-State Batteries. Advanced Materials 2023, 35, 2206402.
25. Sun, H.; Celadon, A.; Cloutier, S. G.; Al-Haddad, K.; Sun, S.; Zhang, G. Lithium Dendrites in All-solid-state Batteries: From Formation to Suppression. Battery Energy 2024, 20230062.
26. Kodgire, P.; Tripathi, B.; Chandra, P. Review of Garnet-Based Solid Electrolytes for Li-Ion Batteries (LIBs). J Electron Mater 2024, 1-26.
27. Zhang, S.; Zhao, H.; Wang, J.; Xu, T.; Zhang, K.; Du, Z. Enhanced Densification and Ionic Conductivity of Li-Garnet Electrolyte: Efficient Li2CO3 Elimination and Fast Grain-Boundary Transport Construction. Chemical Engineering Journal 2020, 393, 124797, doi:https://doi.org/10.1016/j.cej.2020.124797.
28. Li, J.; Gong, Z.; Xie, W.; Yu, S.; Wei, Y.; Li, D.; Yang, L.; Chen, D.; Li, Y.; Chen, Y. Growth Process and Removal of Interface Contaminants for Garnet-Based Solid-State Lithium Metal Batteries. ACS Appl Energy Mater 2023, 6, 12432-12441, doi:10.1021/acsaem.3c02319.
29. Liu, J.; Guo, W.; Guo, H.; Xu, C.; Zhang, L.; Chen, Y.; Shen, F.; Han, X. A Simple and Efficient Strategy for Ameliorating Li/LLZO Interfacial Contact. Energy & Fuels 2022, 36, 8500-8505, doi:10.1021/acs.energyfuels.2c01770.
30. Xu, J.; Tian, W.; Lu, K.; Shan, S.; Zhang, J.; Wu, Y.; Wu, M.; Tang, W. Effect of Acid Treatment of Li7La3Zr2O₁₂ on Ionic Conductivity of Composite Solid Electrolytes. IOP Conf Ser Earth Environ Sci 2020, 512, 012110, doi:10.1088/1755-1315/512/1/012110.
31. Zhang, S.; Zhao, H.; Wang, J.; Xu, T.; Zhang, K.; Du, Z. Enhanced Densification and Ionic Conductivity of Li-Garnet Electrolyte: Efficient Li2CO3 Elimination and Fast Grain-Boundary Transport Construction. Chemical Engineering Journal 2020, 393, 124797, doi:https://doi.org/10.1016/j.cej.2020.124797.
32. Li, J.; Gong, Z.; Xie, W.; Yu, S.; Wei, Y.; Li, D.; Yang, L.; Chen, D.; Li, Y.; Chen, Y. Growth Process and Removal of Interface Contaminants for Garnet-Based Solid-State Lithium Metal Batteries. ACS Appl Energy Mater 2023, 6, 12432-12441, doi:10.1021/acsaem.3c02319.
33. Huo, H.; Chen, Y.; Zhao, N.; Lin, X.; Luo, J.; Yang, X.; Liu, Y.; Guo, X.; Sun, X. In-Situ Formed Li2CO3-Free Garnet/Li Interface by Rapid Acid Treatment for Dendrite-Free Solid-State Batteries. Nano Energy 2019, 61, 119-125, doi:https://doi.org/10.1016/j.nanoen.2019.04.058.
34. Zhang, H.; Paggiaro, G.; Okur, F.; Huwiler, J.; Cancellieri, C.; Jeurgens, L. P. H.; Chernyshov, D.; van Beek, W.; Kovalenko, M. V; Kravchyk, K. V On High-Temperature Thermal Cleaning of Li7La3Zr2O₁₂ Solid-State Electrolytes. ACS Appl Energy Mater 2023, 6, 6972-6980, doi:10.1021/acsaem.3c00459.
35. Li, Y.; Xu, B.; Xu, H.; Duan, H.; Lü, X.; Xin, S.; Zhou, W.; Xue, L.; Fu, G.; Manthiram, A. Hybrid Polymer/Garnet Electrolyte with a Small Interfacial Resistance for Lithium-ion Batteries. Angewandte Chemie International Edition 2017, 56, 753-756.
36. Noeske, M.; Degenhardt, J.; Strudthoff, S.; Lommatzsch, U. Plasma Jet Treatment of Five Polymers at Atmospheric Pressure: Surface Modifications and the Relevance for Adhesion. Int J Adhes Adhes 2004, 24, 171-177, doi:https://doi.org/10.1016/j.ijadhadh.2003.09.006.
37. Kim, M. C.; Yang, S. H.; Boo, J.-H.; Han, J. G. Surface Treatment of Metals Using an Atmospheric Pressure Plasma Jet and Their Surface Characteristics. Surf Coat Technol 2003, 174-175, 839-844, doi:https://doi.org/10.1016/S0257-8972(03)00560-7.
38. Fridman, A. Plasma Chemistry; Cambridge University Press, 2008; ISBN 9781139471732.
39. Lopes, B. B.; Ayres, A. P. A.; Lopes, L. B.; Negreiros, W. M.; Giannini, M. The Effect of Atmospheric Plasma Treatment of Dental Zirconia Ceramics on the Contact Angle of Water. Applied Adhesion Science 2014, 2, 17, doi:10.1186/2196-4351-2-17.
40. Birdos, L.; Barinkovi, H. Cold Atmospheric Plasma: Sources, Processes, and Applications. Thin Solid Films 2010, 518, 6705-6713.
41. Zabidi, N. Z. A.; Zaaba, S. K.; Sut, K. D. E.; Mohamad, C.; Masiman, R. I. A Brief Review on Atmospheric Air Plasma. In Proceedings of the Journal of Physics: Conference Series; IOP Publishing, 2021; Vol. 2071, p. 012004.
42. Rolston, N.; Scheideler, W. J.; Flick, A. C.; Chen, J. P.; Elmaraghi, H.; Sleugh, A.; Zhao, O.; Woodhouse, M.; Dauskardt, R. H. Rapid Open-Air Fabrication of Perovskite Solar Modules. Joule 2020, 4, 2675-2692.
43. Rolston, N.; Sleugh, A.; Chen, J. P.; Zhao, O.; Colburn, T. W.; Flick, A. C.; Dauskardt, R. H. Perspectives of Open-Air Processing to Enable Perovskite Solar Cell Manufacturing. Front Energy Res 2021, 9, 684082.
44. Hovish, M. Q.; Hilt, F.; Rolston, N.; Xiao, Q.; Dauskardt, R. H. Open Air Plasma Deposition of Superhydrophilic Titania Coatings. Adv Funct Mater 2019, 29, 1806421.
45. Bárdos, L.; Baránková, H. Cold Atmospheric Plasma: Sources, Processes, and Applications. Thin Solid Films 2010, 518, 6705-6713, doi:https://doi.org/10.1016/j.tsf.2010.07.044.
46. Kewitz, T.; Regula, C.; Fröhlich, M.; Ihde, J.; Kersten, H. Influence of the Nozzle Head Geometry on the Energy Flux of an Atmospheric Pressure Plasma Jet. EP J Techn Instrum 2021, 8.
47. Rolston, N.; Sleugh, A.; Chen, J. P.; Zhao, 0.; Colburn, T. W.; Flick, A. C.; Dauskardt, R. H. Perspectives of Open-Air Processing to Enable Perovskite Solar Cell Manufacturing. Front Energy Res 2021, 9.
48. Xia, W.; Xu, B.; Duan, H.; Tang, X.; Guo, Y.; Kang, H.; Li, H.; Liu, H. Reaction Mechanisms of Lithium Garnet Pellets in Ambient Air: The Effect of Humidity and CO2. Journal of the American Ceramic Society 2017, 100, 2832-2839.
49. Asma Sharafi Microstructural and Interface Engineering of Garnet-Type Fast Li-Ion-Conductor for Use in Solid-State Batteries, University of Michigan: Ann Arbor, 2017.
50. Mosqueda, H. A.; Vazquez, C.; Bosch, P.; Pfeiffer, H. Chemical Sorption of Carbon Dioxide (CO2) on Lithium Oxide (Li2O). Chemistry of Materials 2006, 18, 2307-2310.
51. Pfeiffer, H.; Sánchez-Sánchez, J.; Álvarez, L. J. Lithium and Tritium Diffusion in Lithium Oxide (Li2O), a Molecular Dynamics Simulation. Journal of nuclear materials 2000, 280, 295-303.
52. Guo, J.; Weller, J. M.; Yang, S.; Bhat, M. H.; Chan, C. K. Reactive Sintering of Garnet-Type Li6.4La3Zr1.4Ta0.6O12 (LLZTO) from Pyrochlore Precursors Prepared Using a Non-Aqueous Sol-Gel Method. Ionics (Kiel) 2023, 29, 581-590, doi:10.1007/s11581-022-04837-4.
53. Guo, J.; Chan, C. K. Lithium Dendrite Propagation in Ta-Doped Li7La3Zr2O12 (LLZTO): Comparison of Reactively Sintered Pyrochlore-to-Garnet vs LLZTO by Solid-State Reaction and Conventional Sintering. ACS Appl Mater Interfaces 2024, 16, 4519-4529, doi:10.1021/acsami.3c11421.
54. Weller, J. M.; Whetten, J. A.; Chan, C. K. Nonaqueous Polymer Combustion Synthesis of Cubic Li7La3Zr2O12 Nanopowders. ACS Appl Mater Interfaces 2020, 12, 953-962, doi:10.1021/acsami.9b19981.
55. Badami, P.; Weller, J. M.; Wahab, A.; Redhammer, G.; Ladenstein, L.; Rettenwander, D.; Wilkening, M.; Chan, C. K.; Kannan, A. N. M. Highly Conductive Garnet-Type Electrolytes: Access to Li6.5La3Zr1.5Ta0.5O12 Prepared by Molten Salt and Solid-State Methods. ACS Appl Mater Interfaces 2020, 12, 48580-48590.
56. Li, Y.; Han, J.-T.; Wang, C.-A.; Xie, H.; Goodenough, J. B. Optimizing Li+ Conductivity in a Garnet Framework. J Mater Chem 2012, 22, 15357-15361, doi:10.1039/C2JM31413D.
57. NIST X-Ray Photoelectron Spectroscopy Database. NIST Standard Reference Database Number 20 2000.
58. Greczynski, G.; Hultman, L. Referencing to Adventitious Carbon in X-Ray Photoelectron Spectroscopy: Can Differential Charging Explain C is Peak Shifts?Appl Surf Sci 2022, 606, 154855.
59. Fairley, N.; Fernandez, V.; Richard-Plouet, M.; Guillot-Deudon, C.; Walton, J.; Smith, E.; Flahaut, D.; Greiner, M.; Biesinger, M.; Tougaard, S. Systematic and Collaborative Approach to Problem Solving Using X-Ray Photoelectron Spectroscopy. Applied Surface Science Advances 2021, 5, 100112.
60. Shirley, D. A. High-Resolution X-Ray Photoemission Spectrum of the Valence Bands of Gold. Phys Rev B 1972, 5, 4709.
61. Sharafi, A.; Kazyak, E.; Davis, A. L.; Yu, S.; Thompson, T.; Siegel, D. J.; Dasgupta, N. P.; Sakamoto, J. Surface Chemistry Mechanism of Ultra-Low Interfacial Resistance in the Solid-State Electrolyte Li7La3Zr2O12. Chemistry of Materials 2017, 29, 7961-7968.
62. Jain, V.; Biesinger, M. C.; Linford, M. R. The Gaussian-Lorentzian Sum, Product, and Convolution (Voigt) Functions in the Context of Peak Fitting X-Ray Photoelectron Spectroscopy (XPS) Narrow Scans. Appl Surf Sci 2018, 447, 548-553, doi:https://doi.org/10.1016/j.apsusc.2018.03.190.
63. Wood, K. N.; Teeter, G. XPS on Li-Battery-Related Compounds: Analysis of Inorganic SEI Phases and a Methodology for Charge Correction. ACS Appl Energy Mater 2018, 1, 4493-4504.
64. Wei, Y.; Xu, H.; Cheng, H.; Guan, W.; Yang, J.; Li, Z.; Huang, Y. An Oxygen Vacancy-Rich ZnO Layer on Garnet Electrolyte Enables Dendrite-Free Solid State Lithium Metal Batteries. Chemical Engineering Journal 2022, 433, 133665.
65. Lourens, F.; Rogalla, D.; Suhr, E.; Ludwig, A. On the Influence of Annealing on the Compositional and Crystallographic Properties of Sputtered Li—Al—O Thin Films. arXiv preprint arXiv:2402.06553 2024.
66. Fantin, R.; Van Roekeghem, A.; Benayad, A. Revisiting Co 2p Core-level Photoemission in LiCoO2 by In-lab Soft and Hard X-ray Photoelectron Spectroscopy: A Depth-dependent Study of Cobalt Electronic Structure. Surface and Interface Analysis 2023, 55, 489-495.
67. Jones, J. C.; Rajendran, S.; Pilli, A.; Lee, V.; Chugh, N.; Arava, L. M. R.; Kelber, J. A. In Situ X-Ray Photoelectron Spectroscopy Study of Lithium Carbonate Removal from Garnet-Type Solid-State Electrolyte Using Ultra High Vacuum Techniques. Journal of Vacuum Science & Technology A 2020, 38.
68. Weller, J. M.; Chan, C. K. Synthesis of Nanostructured Garnets. Solid Electrolytes for Advanced Applications: Garnets and Competitors 2019, 25-68.
69. Chan, C. K.; Yang, T.; Weller, J. M. Nanostructured Garnet-Type Li7La3Zr2O12: Synthesis, Properties, and Opportunities as Electrolytes for Li-Ion Batteries. Electrochim Acta 2017, 253, 268-280.
70. Weller, J. M.; Chan, C. K. Reduction in Formation Temperature of Ta-Doped Lithium Lanthanum Zirconate by Application of Lux-Flood Basic Molten Salt Synthesis. ACS Appl Energy Mater 2020, 3, 6466-6475, doi:10.1021/acsaem.0c00716.
71. Sharafi, A.; Yu, S.; Naguib, M.; Lee, M.; Ma, C.; Meyer, H. M.; Nanda, J.; Chi, M.; Siegel, D. J.; Sakamoto, J. Impact of Air Exposure and Surface Chemistry on Li—Li 7 La 3 Zr 2 O 12 Interfacial Resistance. J Mater Chem A Mater 2017, 5, 13475-13487.
72. Zhou, X.; Liu, J.; Ouyang, Z.; Liu, F.; Zhang, Z.; Lai, Y.; Li, J.; Jiang, L. In-Situ Construction of Electronically Insulating and Air-Stable Ionic Conductor Layer on Electrolyte Surface and Grain Boundary to Enable High-Performance Garnet-Type Solid-State Batteries. Small 2024, 2402086.
73. Sharafi, A.; Yu, S.; Naguib, M.; Lee, M.; Ma, C.; Meyer, H. M.; Nanda, J.; Chi, M.; Siegel, D. J.; Sakamoto, J. Impact of Air Exposure and Surface Chemistry on Li—Li 7 La 3 Zr 2 O 12 Interfacial Resistance. J Mater Chem A Mater 2017, 5, 13475-13487.
74. Contarini, S.; Rabalais, J. W. Ion Bombardment-Induced Decomposition of Li and Ba Sulfates and Carbonates Studied by X-Ray Photoelectron Spectroscopy. J Electron Spectros Relat Phenomena 1985, 35, 191-201.
75. Zhang, H.; Paggiaro, G.; Okur, F.; Huwiler, J.; Cancellieri, C.; Jeurgens, L. P. H.; Chernyshov, D.; van Beek, W.; Kovalenko, M. V; Kravchyk, K. V On High-Temperature Thermal Cleaning of Li7La3Zr2O12 Solid-State Electrolytes. ACS Appl Energy Mater 2023, 6, 6972-6980.
76. Vema, S.; Sayed, F. N.; Nagendran, S.; Karagoz, B.; Sternemann, C.; Paulus, M.; Held, G.; Grey, C. P. Understanding the Surface Regeneration and Reactivity of Garnet Solid-State Electrolytes. ACS Energy Lett 2023, 8, 3476-3484.
77. Li, J.; Gong, Z.; Xie, W.; Yu, S.; Wei, Y.; Li, D.; Yang, L.; Chen, D.; Li, Y.; Chen, Y. Growth Process and Removal of Interface Contaminants for Garnet-Based Solid-State Lithium Metal Batteries. ACS Appl Energy Mater 2023, 6, 12432-12441.
78. Cheng, L.; Crumlin, E. J.; Chen, W.; Qiao, R.; Hou, H.; Lux, S. F.; Zorba, V.; Russo, R.; Kostecki, R.; Liu, Z. The Origin of High Electrolyte-Electrode Interfacial Resistances in Lithium Cells Containing Garnet Type Solid Electrolytes. Physical Chemistry Chemical Physics 2014, 16, 18294-18300.
79. Wu, J.-F.; Pu, B.-W.; Wang, D.; Shi, S.-Q.; Zhao, N.; Guo, X.; Guo, X. In Situ Formed Shields Enabling Li2CO3-Free Solid Electrolytes: A New Route to Uncover the Intrinsic Lithiophilicity of Garnet Electrolytes for Dendrite-Free Li-Metal Batteries. ACS Appl Mater Interfaces 2018, 11, 898-905.
80. Cheng, L.; Liu, M.; Mehta, A.; Xin, H.; Lin, F.; Persson, K.; Chen, G.; Crumlin, E. J.; Doeff, M. Garnet Electrolyte Surface Degradation and Recovery. ACS Appl Energy Mater 2018, 1, 7244-7252.
81. Huo, H.; Luo, J.; Thangadurai, V.; Guo, X.; Nan, C.-W.; Sun, X. Li2CO3: A Critical Issue for Developing Solid Garnet Batteries. ACS Energy Lett 2019, 5, 252-262.
82. Zhang, H.; Paggiaro, G.; Okur, F.; Huwiler, J.; Cancellieri, C.; Jeurgens, L. P. H.; Chernyshov, D.; van Beek, W.; Kovalenko, M. V; Kravchyk, K. V On High-Temperature Thermal Cleaning of Li7La3Zr2O12 Solid-State Electrolytes. ACS Appl Energy Mater 2023, 6, 6972-6980.
83. Shi, C.; Takeuchi, S.; Alexander, G. V; Hamann, T.; O'Neill, J.; Dura, J. A.; Wachsman, E. D. High Sulfur Loading and Capacity Retention in Bilayer Garnet Sulfurized-Polyacrylonitrile/Lithium-Metal Batteries with Gel Polymer Electrolytes. Adv Energy Mater 2023, 13, 2301656.
84. Wang, C.; Xie, H.; Ping, W.; Dai, J.; Feng, G.; Yao, Y.; He, S.; Weaver, J.; Wang, H.; Gaskell, K. A General, Highly Efficient, High Temperature Thermal Pulse toward High Performance Solid State Electrolyte. Energy Storage Mater 2019, 17, 234-241.

### ADDITIONAL REFERENCES CITED HEREIN

1. Xia, W.; Xu, B.; Duan, H.; Tang, X.; Guo, Y.; Kang, H.; Li, H.; Liu, H. Reaction Mechanisms of Lithium Garnet Pellets in Ambient Air: The Effect of Humidity and CO2. Journal of the American Ceramic Society 2017, 100, 2832-2839, doi:https://doi.org/10.1111/jace.14865.
2. Xia, W.; Xu, B.; Duan, H.; Guo, Y.; Kang, H.; Li, H.; Liu, H. Ionic Conductivity and Air Stability of Al-Doped Li7La3Zr2O12 Sintered in Alumina and Pt Crucibles. ACS Appl Mater Interfaces 2016, 8, 5335-5342, doi:10.1021/acsami.5b12186.
3. Lu, W.; Wang, T.; Xue, M.; Zhang, C. Improved Li6.5La3Zr1.5Nb0.5O12 Electrolyte and Effects of Atmosphere Exposure on Conductivities. J Power Sources 2021, 497, 229845, doi: https://doi.org/10.1016/j.jpowsour.2021.229845.
4. Han, S.; Wang, Z.; Ma, Y.; Zhang, Y.; Wang, Y.; Wang, X. Recent Advances in Solving Li2CO3 Problems in Garnet-Based Solid-State Battery: A Systematic Review (2020-2023). Journal of Energy Chemistry 2024, 90, 58-76, doi:https://doi.org/10.1016/j.jechem.2023.10.040.
5. Lan, W.; Lu, D.; Zhao, R.; Chen, H. Investigation of Al₂O3 Crucible Contamination Induced by Extra Li2CO3 during Li7La3Zr2O12 Solid Electrolyte Sintering Process. Int J Electrochem Sci 2019, 14, 9695-9703, doi:https://doi.org/10.20964/2019.10.22.
6. Brugge, R. H.; Hekselman, A. K. O.; Cavallaro, A.; Pesci, F. M.; Chater, R. J.; Kilner, J. A.; Aguadero, A. Garnet Electrolytes for Solid State Batteries: Visualization of Moisture-Induced Chemical Degradation and Revealing Its Impact on the Li-Ion Dynamics. Chemistry of Materials 2018, 30, 3704-3713, doi:10.1021/acs.chemmater.8b00486.
7. Cheng, L.; Liu, M.; Mehta, A.; Xin, H.; Lin, F.; Persson, K.; Chen, G.; Crumlin, E. J.; Doeff, M. Garnet Electrolyte Surface Degradation and Recovery. ACS Appl Energy Mater 2018, 1, 7244-7252.
8. Zhang, H.; Paggiaro, G.; Okur, F.; Huwiler, J.; Cancellieri, C.; Jeurgens, L. P. H.; Chernyshov, D.; van Beek, W.; Kovalenko, M. V; Kravchyk, K. V On High-Temperature Thermal Cleaning of Li7La3Zr2O12 Solid-State Electrolytes. ACS Appl Energy Mater 2023, 6, 6972-6980.
9. Li, Y.; Xu, B.; Xu, H.; Duan, H.; LU, X.; Xin, S.; Zhou, W.; Xue, L.; Fu, G.; Manthiram, A. Hybrid Polymer/Garnet Electrolyte with a Small Interfacial Resistance for Lithium-ion Batteries. Angewandte Chemie International Edition 2017, 56, 753-756.

### Example 2

### Open-Air Plasma Removal of Lithium Carbonate for High Performance Solid-State Electrolytes

### Non-Limiting Summation

This disclosure describes a new process to treat the surface of Li-ion battery materials with open-air plasma. The plasma process can enable rapid removal of undesired compounds from the surfaces of materials which are known to introduce surface resistance, interface impedance, and inhibit charge transfer. Removal of the compounds with the plasma can improve the surface and interface properties of the material and improve device performance. The plasma process was used to convert undesired lithium carbonate phases of low Li conductivity from the surface of the solid-state electrolyte lithium lanthanum zirconate (Li₇La₃Zr₂O₁₂, LLZO). The resulting material showed an improved surface chemistry, ionic conductivity, and wettability to Li which ultimately improves cyclability, durability, and performance of solid-state batteries.

### Non-Limiting Features of Interest

Open-air plasma was used to remove undesired compounds from the surface of Li ion battery materials.
Open-air plasma was used to remove undesired compounds from the surface of Li ion battery materials.

We have discovered a device to process materials with open-air plasma and have tested this device to process LLZO solid electrolyte which indicated improved performance.

### Non-Limiting Brief Description

This disclosure describes the use of an open-air plasma processing method to carry out the surface treatment of lithium-ion battery materials. The plasma process can enable rapid removal of undesired compounds from the surface of the material which are known to introduce surface resistance, interface impedance, and inhibit charge transfer. Removal of the compounds with the plasma can improve the surface and interface properties of the material and improve device performance. One specific implementation of the invention is the conversion of undesired lithium carbonate phases from solid-state electrolytes such as lithium lanthanum zirconate using the open-air plasma.

### Background

Open-air plasma technology is a unique and tunable alternate heat source that is compatible with a range of materials and device structures. It offers an advantage over conventionally used RF or microwave plasmas because it can rapidly transform materials at a controllable temperature. For example, Rolston used open-air plasmas to develop of a “method for forming perovskite layers using atmospheric pressure plasma” (U.S. Ser. No. 10/636,632B2) where the deposition of perovskite ink is followed by an atmospheric pressure plasma that efficiently cures the precursor to fabricate perovskite films for photovoltaic devices. This disclosure can apply open-air plasma technology to the processing of materials used in lithium batteries. The ability to store electrical energy safely and inexpensively is a key component of future energy systems, long-range electric vehicles, and long-lasting electronics. State-of-the-art Li-ion batteries employing liquid organic electrolytes have significant drawbacks in safety, reliability, capacity, and lifetime. Solid electrolytes can replace flammable liquids, display improved (electro)chemical stability, and provide a physical barrier against short circuits caused by lithium dendrite propagation, leading to improved reliability, prolonged battery life, and increased energy density. Recently, there has been increased focus by battery manufacturers and the automotive industry on the development of solid-state batteries. Lithium lanthanum zirconate (Li₇La₃Zr₂O₁₂, LLZO) is a lithium conducting ceramic with many promising characteristics for use as solid electrolyte in solid-state batteries. However, a major obstacle to the commercialization of LLZO and its implementation into solid-state batteries is the challenge in processing the materials with favorable interfacial properties to achieve batteries with the desired cycling performance, energy, and power.

While LLZO can be synthesized and processed in ambient conditions, spontaneous reactions with water vapor and carbon dioxide can cause lithium carbonate (Li₂CO₃) formation on the LLZO surface, which can lead to poor interfacial properties, formation of Li-deficient LLZO with low ionic conductivity, and poor integration of the solid electrolyte with the anode and cathode. Research has shown that a layer of Li₂CO₃ only a few tens to hundreds of nanometers thick can increase its interfacial resistance by an order of magnitude, which is problematic since low interface resistance is required for strong adhesion of Li metal anodes to LLZO and efficient electrochemical cycling. Additionally, Li₂CO₃ can react deleteriously with cathode materials and release CO₂ during battery charging, increasing the internal cell pressure of the batteries. Li₂CO₃ can be removed with mechanical polishing or high temperature heating under Ar atmosphere, but these treatments are not amenable to scalable manufacturing. Therefore, new processes that can enable Li₂CO₃ removal from the surface of LLZO are needed.

### Non-Limiting Description

We describe herein, an open-air plasma is used to treat the surface of a solid-state electrolyte to remove Li₂CO₃ and secondary phases with low Li conductivity. The resulting material has an improved surface chemistry, ionic conductivity, and wettability to Li which ultimately improves cyclability, durability, and performance of solid-state batteries. The uniqueness of the atmospheric pressure (open-air) plasma system is the combination of energy sources which are generated: electrons and reactive species (radicals, metastables, and photons) are produced in combination with convective heat to rapidly transfer energy to enable ultrafast precursor conversion or post-treatment. The process also can also be implemented in a roll-to-roll fashion to enable scalable processing of the materials.

While the example describes the removal of Li₂CO₃ from the surface of the LLZO solid electrolyte, without wishing to be bound by theory, the open-air plasma can be used to clean the surfaces of other solid electrolyte as well as water sensitive cathode materials such as lithium nickel manganese cobalt oxide.

### Non-Limiting Summation

This disclosure can apply open-air plasma technology to the processing of materials used in lithium batteries. The ability to store electrical energy safely and inexpensively is a key component of future energy systems, long-range electric vehicles, and long-lasting electronics. State-of-the-art Li-ion batteries employing liquid organic electrolytes have significant drawbacks in safety, reliability, capacity, and lifetime. Solid electrolytes can replace flammable liquids, display improved (electro)chemical stability, and provide a physical barrier against short circuits caused by lithium dendrite propagation, leading to improved reliability, prolonged battery life, and increased energy density. Recently, there has been increased focus by battery manufacturers and the automotive industry on the development of solid-state batteries. Lithium lanthanum zirconate (Li₇La₃Zr₂O₁₂, LLZO) is a lithium conducting ceramic with many promising characteristics for potential use as solid electrolyte in solid-state batteries. However, a major obstacle to the commercialization of LLZO and its implementation into solid-state batteries is the challenge in processing the materials with favorable interfacial properties to achieve batteries with the desired cycling performance, energy, and power. This invention uses a new process to modify the surfaces and interfaces of materials to remove undesired compounds.

### Non-Limiting Unexpected Features

This disclosure addresses several challenges that need to be overcome within the field of solid-state electrolytes, particularly with regards to ionic conductivity and manufacturing cost:
Open Air: The material can be created in an open-air environment, unlike typical solid-state electrolyte processes involving LLZO. Despite the presence of moisture and oxygen during processing, the open-air plasma creates a locally inert environment around the sample.
Low cost production: This material does not require high-temperature sintering to produce a stable electrolyte, greatly reducing manufacturing time and cost.
Ion conductivity: This material has a comparable ion conductivity to LLZO that has been treated with conventional, more expensive processes to remove lithium carbonate. Combined with the significantly easier manufacturing process, this material is far better for most applications for SSEs.

### Non-Limiting Advantages

Current forms of lithium carbonate removal involve mechanical polishing/grinding or high-temperature treatments for long periods of time (multiple hours) and the need to process in an inert or vacuum environment. This can also be used on both pellets and thin films, whereby polishing/grinding has the possibility to create defects and damage to thin films. The increase in Li wetting/mechanical adhesion is achieved through control of surface functionality from the plasma treatment.

### Non-Limiting Applications

This disclosure has applications in next generation solid state battery. This comprises high energy density batteries for consumer electronics to electric vehicles. The lightweight and extremely low cost process enables applications in UAVs, drones, satellites, trucking (providing energy for refrigeration), residential, commercial, and eventually grid-scale energy storage.

### REFERENCES CITED HEREIN

1. Method for forming perovskite layers using atmospheric pressure plasma (U.S. Ser. No. 10/636,632B2)
2. Rolston et al. Joule, 4, 12 (2020), pg 2675 Rapid Open-Air Fabrication of Perovskite Solar Modules (10.1016/j.joule.2020.11.001)
3. Zhang et al. ACS Applied Energy Materials, 2023, 6, pg 6972 On High-Temperature Thermal Cleaning of Li7La3Zr2O12 Solid-State Electrolytes (10.1021/acsaem.3i c00459).

What is claimed is:

1. A method of removing Li₂CO₃ from a lithium-ion solid-state electrolyte material to improve material performance, the method comprising:
exposing a lithium-ion solid-state electrolyte material to an atmospheric plasma discharge for an exposure period, thereby removing Li₂CO₃; and
terminating the atmospheric plasma discharge exposure, thereby producing a solid-state electrolyte with improved material performance.

2. The method of claim 1, the atmospheric plasma discharge source is modified with a shroud surrounding the plasma discharge source, and wherein the shroud comprises a shroud gas injection source.

3. The method of claim 2, wherein shroud generates higher fluxes and increases surface reactions.

4. The method of claim 1, further comprising flowing a shroud gas over the material after terminating the plasma discharge exposure, thereby cooling the material and decreasing side reactions.

5. The method of claim 1, wherein the atmospheric plasma discharge is thermal or nonthermal.

6. The method of claim 5, wherein the nonthermal atmospheric plasma discharge comprises corona discharges, atmospheric pressure glow discharges, dielectric barrier discharges, and blown arc discharges; and wherein the thermal atmospheric plasma discharge comprises high-intensity arc discharges and plasma torches.

7. The method of claim 1, wherein the exposure period comprises about 5 seconds to about 1 hour.

8. The method of claim 1, wherein the atmospheric plasma discharge is open to ambient air or is contained within an enclosure providing a controlled atmosphere.

9. The method of claim 1, wherein the plasma discharge is a non-thermal blown-arc discharge.

10. The method of claim 1, wherein the plasma discharge temperature comprises a temperature of less than about 100° C. to about 3000° C.

11. The method of claim 1, wherein the atmospheric plasma discharge has an ionization gas flow rate of about 15 lpm to about 50 lpm.

12. The method of claim 1, wherein the atmospheric plasma discharge source is at a distance of about 0.5 mm to about 10 mm from the material during the exposure period.

13. The method of claim 1, wherein the shroud gas is selected from N₂, O₂, Ar, or a combination thereof.

14. The method claim 1, wherein the shroud gas is flowed over the material at a rate of about 5 lpm to about 100 lpm.

15. The method of claim 1, wherein the lithium-ion solid-state electrolyte is a lithium lanthanum zirconium oxide (Li₇La₃Zr₂O₁₂).

16. The method of claim 15, wherein the lithium lanthanum zirconium oxide further comprises one or more dopants selected from the group consisting of Al, Ga, Nb, or Ta.

17. The method of claim 16, wherein the lithium lanthanum zirconium oxide is Li_{6.4}La₃Zr_{1.4}Ta_{0.6}O₁₂.

18. The method of claim 1, wherein the improved performance comprises an increase in conductivity and a decrease in decrease in interfacial resistance.

19. A solid-state electrolyte processed by the method of claim 1.

20. An atmospheric plasma discharge device comprising a plasma discharge source surrounded by a shroud, wherein the shroud comprises a shroud gas inlet.
